(19) United States
(12) Patent Application Publication
(10) Pub. No.: US 2025/0278864 A1
(43) Pub. Date: Sep. 4, 2025

(54) GRAPHICS TEXTURE PROCESSING

(71) Applicant: Arm Limited, Cambridge (GB)

(72) Inventors: Daren Croxford, Swaffham Prior (GB); Roberto Lopez Mendez, Cambridge (GB); Mina Ivanova Dimova, Great Shelford (GB)

(73) Assignee: Arm Limited, Cambridge (GB)

(21) Appl. No.: 18/591,931

(22) Filed: Feb. 29, 2024

(51) Int. Cl. G06T 9/00

(52) U.S. Cl. CPC G06T 9/002

(57) ABSTRACT

Disclosed are methods of compressing/decompressing graphics texture data in particular in which a same neural network is used to compress/decompress multiple, different textures. This can therefore facilitate re-use of the same neural network during graphics processor operation when processing a sequence of texturing requests. Also disclosed are methods of processing graphics texture data in which a neural network is used to perform texturing filtering operations.

### BACKGROUND

The technology described herein relates to graphics processor texturing operations, and in particular to the compression/decompression of graphics texture data.

It is common in graphics processing systems to generate data values (e.g. colours) for sampling positions in a render output (e.g. image to be displayed) by applying so-called textures or texture data to the surfaces to be drawn. Such textures are typically applied by storing an array of texture elements or “texels”, each representing given texture data (such as colour, alpha, luminance and/or light/shadow, etc., values), and then mapping the texels onto the corresponding elements, such as (and typically), a set of sampling positions, for the render output in question (e.g. image to be displayed).

Thus a graphics texture will typically be configured as an array of data elements (texture elements (texels)), each having a corresponding set of texture data stored for it. The texture data for a given position within the texture is then determined by sampling the texture at that position (e.g. by using a suitable interpolation process). The stored arrays of texture elements (data) are typically referred to as “texture maps”.

The texture data is typically stored in (external) (e.g. main) memory. When texture data is needed by a graphics processor (e.g. for rendering an image to be displayed), the texture data required for the rendering process is thus usually first fetched from the memory where it is stored and loaded into a cache (e.g. a texture cache) of or accessible to the graphics processor, with the graphics processor (the rendering pipeline implemented by the graphics processor) then reading the texture data from the texture cache for use to perform the desired texturing operations.

The texture data is typically stored in the (external) (e.g. main) memory in a compressed format. Thus, when the graphics processor causes texture data to be fetched from the memory location where it is stored, the texture data must typically then be decompressed into a suitable (i.e. uncompressed) format for use by the graphics processor. It is not generally known in advance which texture data will be required by a given rendering process, and so the texture data should be, and generally is, compressed in such a manner that allows “random access” to the compressed texture data. This random access is typically achieved using block-based compression and various texture compression algorithms are known in this regard that are designed for compressing texture data (e.g., and in particular, that are configured to allow random access to the compressed texture data).

One example of an efficient texture compression scheme is Arm's adaptive scalable texture compression (ASTC) technique, e.g. as described in U.S. Pat. No. 9,058,637 (Arm Limited), but various other compression schemes exist that can also suitably be used for compressing texture data. For instance, other suitable compression schemes may include, but are not limited to, Ericsson Texture Compression (ETC), PowerVR Texture Compression (PVRTC), S3 Texture Compression (S3TC), etc., each of which uses a similar, but slightly different compression algorithm.

To facilitate such graphics processor texturing operations some modern graphics processors include a dedicated (hardware) texture mapping unit that provides an interface to the memory location in which the texture data is stored and is accordingly operable and configured to manage requests from the graphics processor for texture data, with the texture decompression accordingly being performed at a suitable point along the texture mapping unit's memory access path. For instance, in some modern graphics processors, the texture mapping unit may interface, and connect, to a “texture cache system” that provides one or more levels of caching and which “texture cache system” also includes, or has access to, one or more dedicated hardware circuits that are operable to decompress the texture data that is fetched from the memory before it is provided to the graphics processor via the texture mapping unit (with these hardware circuits typically supporting specific texture compression algorithms such that each supported texture compression algorithm may have its own dedicated hardware circuit). Thus, texture compression may often be performed “on chip” within the texture cache system of a (and each) graphics processor shader (processing) core (rather than within the graphics processor's shared (L2) cache system, for instance, as and when data is transferred to/from the external memory system, as may be done for other types of graphics data (e.g. frame buffer data)).

The present Applicants however believe that there remains scope for improved arrangements for the compression/decompression of graphics texture data (and hence improved graphics processor operation when performing graphics texturing operations).

### BRIEF DESCRIPTION OF THE DRAWINGS

Various embodiments will now be described by way of example only and with reference to the following figures, in which:

FIG. 1 shows schematically an exemplary data processing system in which the technology described herein may be implemented;

FIG. 2 shows schematically an embodiment of a graphics processor including a texture mapping unit that interfaces with a texture cache system that is used to handle graphics processor texturing requests;

FIG. 3 shows the texture mapping unit of the graphics processing system of FIG. 2 in more detail;

FIG. 4 shows an example of graphics texture data;

FIG. 5 shows schematically texture filtering operations that may be performed by the texture mapping unit;

FIG. 6 shows an exemplary sequence of layers of neural network processing comprising an input layer and an output layer, between which are neural network layers comprising various convolutional layer (C-layer) layers and fully-connected layers (FC layer);

FIG. 7 illustrates a sequence of layers of neural network processing, wherein the output feature map from a layer of neural network processing may be written to a suitable buffer and then use as an input feature map for a next layer in the sequence, and wherein each layer of neural network processing may use processing parameters (e.g. such as weights) which are read from a suitable buffer;

FIG. 8 shows schematically training of a neural network to perform graphics texture compression according to an embodiment;

FIG. 9 shows an example of neural network based graphics texture decompression that may be performed according to an embodiment;

FIG. 10 shows another example of neural network based graphics texture decompression that may be performed according to an embodiment;

FIG. 11 shows another example of neural network based graphics texture decompression that may be performed according to an embodiment;

FIG. 12 shows another example of neural network based graphics texture decompression that may be performed according to an embodiment;

FIG. 13 shows another example of neural network based graphics texture decompression that may be performed according to an embodiment;

FIG. 14 shows another example of neural network based graphics texture decompression that may be performed according to an embodiment;

FIG. 15 shows another example of neural network based graphics texture decompression that may be performed according to an embodiment;

FIG. 16 shows another example of neural network based graphics texture decompression that may be performed according to an embodiment;

FIG. 17 shows schematically an example of a graphics processor that may be used according to an embodiment;

FIG. 18 shows schematically an example of a graphics processor that may be used according to another embodiment;

FIG. 19 shows schematically an example of a graphics processor that may be used according to yet another embodiment;

FIG. 20 shows a method of operating a graphics processor when performing a texturing request according to an embodiment;

FIG. 21 shows a method of operating a graphics processor when performing a texturing request according to another embodiment;

FIG. 22 shows a method of operating a graphics processor according to yet another embodiment;

FIG. 23 shows a method of operating a graphics processor according to yet another embodiment;

FIG. 24 shows a method of operating a graphics processor according to yet another embodiment;

FIG. 25 shows an embodiment of a shader program compilation process according to an embodiment of the technology described herein; and

FIG. 26 shows an embodiment of corresponding execution of the shader program that has been compiled by the process of FIG. 25.

Like numerals are used for like features in the drawings (where appropriate).

### DESCRIPTION

A first embodiment of the technology described herein comprises a method of compressing graphics texture data, the method comprising:
selecting a group of plural different textures that are to be compressed using a same neural network; and
using the same neural network to compress different ones of the textures in the selected group of plural different textures.

The technology described herein relates generally to graphics processor texturing operations and in particular to the use of neural network based graphics texture compression/decompression schemes.

For instance, when generating a render output (e.g. an image), a graphics processor may perform texturing operations for sampling positions in the render output (image), e.g. to determine the appearance of the render output at those sampling positions. This typically (and in an embodiment) involves applying a set of graphics texture data defining the texture surface (e.g. in terms of its colour components (e.g. RGB(A) or YUV values), but optionally also in terms other properties of the texture surface, such as luminance and/or light/shadow, etc., values) to respective sampling positions within the render output (image) to determine the appearance (e.g. colour, etc.) that the sampling position(s) should have in the final render output (image).

Thus, graphics texture data, depending on the format in which it is stored and to be used, in an embodiment includes a plurality of data “channels” including at least a set of colour (and optionally transparency) channels (e.g. storing the RGB(A) or YUV colour values for the texture surface in question) but optionally also including one or more other channels storing other properties of the texture surface.

Thus, each texture within the group of plural different textures may itself define a set of texture data defining the texture surface (e.g. in terms of its colour components (e.g. RGB(A) or YUV values), but optionally also in terms other properties of the texture surface, such as luminance and/or light/shadow, etc., values) for respective sampling positions within the render output (image). Each property defining the texture surface of the texture is typically defined as a separate “channel” of the texture, each channel comprising a set of one or more mipmaps that represent the data within the channel at multiple levels of detail. Thus, in an embodiment, each texture within the group of plural different textures has more than four channels, each channel comprising a set of one or more mipmaps defining the data within that channel. That is, in embodiments, the group of plural different textures includes a group of plural different ‘full’ texture “sets” including all of the information (e.g. all of the channels and mipmaps levels) defining the texture in question.

The graphics texture data is stored in a memory system, which may, e.g., and in an embodiment does, comprise a memory that is external to the graphics processor (e.g. main memory). When executing a graphics processing program for which a texturing operation is to be performed, the graphics processor can thus (and does) request graphics texture data for the texturing operation from the memory system, as required, with the requested graphics texture data then being returned to the graphics processor accordingly for use by the graphics processor.

As mentioned above, in order to facilitate storing graphics texture data in the memory system, the graphics texture data is in an embodiment stored in the memory system in a compressed format. Accordingly, when the graphics processor is performing a texturing operation, in response to the graphics processor requesting graphics texture data from the memory system, the requested graphics texture data must first be processed (i.e. decompressed) into a suitable, uncompressed format in which it can be used by the graphics processor.

Various texture compression/decompression schemes exists that are designed and optimised for compressing/decompressing graphics texture data and a graphics processor (and in embodiments the graphics processor according to the technology described herein) may have one or more suitable hardware circuits to support any such texture compression/decompression schemes, as desired.

According to the technology described herein, however, graphics texture data (or at least some graphics texture data) can be (and is) compressed using a neural network based texture compression scheme. That is, according to the technology described herein, (at least some) graphics texture data is compressed by executing one or more neural networks that are suitably configured (e.g. trained) to compress the graphics texture data.

Correspondingly, when such graphics texture data that has been compressed in this way is fetched into the graphics processor from the memory system, the graphics texture data needs to be decompressed from such (neural network) compressed format into a suitable, uncompressed format for use by the graphics processor, and this decompression can be (and is) by executing one or more neural networks that are suitably configured (e.g. trained) to perform the required decompression of the graphics texture data into the desired, uncompressed format for use by the graphics processor.

In principle, neural network based texture decompression may also be used for processing graphics texture data that has been compressed in other ways, e.g. using traditional texture compression schemes. That is, rather than only being used to process (decompress) graphics texture data that has been compressed using a neural network based texture compression scheme, it may also be possible to configure and train a neural network to decompress graphics texture data that has been compressed in some other way. In that case, one or more neural network may be used to emulate some or all steps of a more traditional texture decompression scheme. Various arrangements would be possible in this regard.

In this respect, it will be appreciated that machine learning (e.g., and in particular, machine learning using neural networks) is typically good at ‘generalising’ data. For instance, neural networks, after having been trained on a certain body of training data, can then be used to process new (unseen) data, e.g., and in particular, to make inferences from that new data based on the underlying data distribution that was used for the model training. Thus, the present Applicants have found that by appropriate training of a neural network (or set of neural networks), the trained neural network(s) can provide highly efficient compression of graphics texture data (and, correspondingly, similar, e.g. ‘reverse’, neural network(s) can be used to provide effective decompression of graphics texture data that has been compressed in this way).

In particular, compared to traditional graphics texture data compression schemes, neural network based texture compression/decompression may often be able to provide relatively higher compression rates and/or image quality.

Neural network based texture compression/decompression may also advantageously provide increased flexibility and configurability since the neural network(s) can be suitably configured and trained to compress/decompress graphics texture data in any desired format, and so neural network based texture compression and decompression schemes can be configured to provide any desired number of channels, quality level, compression rate, etc., and then deployed appropriately to do this (whereas existing graphics texture data compression schemes are typically designed only to compress certain formats of data having a fixed number of channels, e.g. RGB (three channels) or RGBA (four channels), such that where additional channels are desired, these additional channels may need to be stored as a separate graphics texture that has to then be fetched and decompressed separately to the graphics texture storing the colour values, which therefore requires additional memory bandwidth, etc., Storing these additional channels in this manner may also be relatively inefficient as existing graphics texture data compression schemes may not have been optimised for these additional channels, and therefore may not compress these channels particularly effectively).

Thus, the present Applicants have found that there may be various benefits to using neural network based texture compression/decompression schemes in graphics processing applications.

A particular effect and benefit of using the neural network based texture compression/decompression schemes of the technology described herein is that this then offers increased flexibility and configurability as to how the graphics texture data is compressed/decompressed (whereas traditional texture compression schemes are typically relatively constrained by what is supported in the respective hardware decompression blocks (circuits)).

For example, according to the first embodiment of the technology described herein, a same (first) neural network is configured and trained to compress multiple different textures (i.e. different texture types/content, having different colour, etc., channels) within a selected group of plural different textures. That is, the present Applicants recognise that it may be beneficial to configure a single, same (first) neural network to perform compression for a selected group of plural, different (albeit potentially related) textures. Thus, each individual texture in the selected group of plural, different textures can be (and in an embodiment is) compressed using the single, same (first) neural network.

The effect and benefit of this is that a corresponding single, same (second) neural network can then be used to perform the required decompression of any of the individual textures within such a selected group of plural, different textures (i.e. that have been compressed using the same neural network). This can then potentially reduce instances of having to load/re-load multiple different neural networks into the graphics processor when performing a sequence of texturing requests that may require different graphics textures to be processed.

The technology described herein also extends to such decompression techniques. Thus, a second embodiment of the technology described herein comprises a method of decompressing graphics texture data, the method comprising:
for a group of plural different textures stored in a first, compressed format, where the different textures in the group of plural different textures are selected such that a same neural network can be used to decompress different ones of the textures in the group of plural different textures:
using the same neural network to decompress multiple, different ones of the textures in the group of plural different textures.

This can then provide various benefits compared to other possible approaches. For example, in another approach, a single neural network could in principle be configured and trained to process any and all types of graphics textures. However, this may not offer optimal compression/decompression for all different graphics textures, such that for improved performance, it may be desired to have a plurality of different neural networks available that can be selected, e.g. based on the texture (type/content) that is required, to perform the required texture decompression.

In the simplest such case, separate neural networks may be used for each different texture (type/content) and each level of detail. In that case, the graphics processor should select, based on the texture (type/content) and level of detail that is required, the appropriate neural network or networks from a plurality of neural networks that are available and then load the selected neural network(s) into the neural processing circuit so that the required graphics texture can be processed using the selected neural network(s) accordingly. However, in that case, (data for) a different neural network may need to be loaded into the graphics processor for every texturing request requiring a different texture. This can therefore lead to relatively higher bandwidth and storage requirements for supporting the different graphics textures that may be required during a particular graphics processing operation.

Thus, according to the first embodiment of the technology described herein, when configuring (training) a neural network (or set of neural networks) to perform the desired texture compression, a group of plural, different textures (i.e. different texture types having different content, e.g. representing different texture details, surface properties, colours, etc.) that can/should be compressed/decompressed using the same neural network is selected, and a single, same (first) neural network is then used to individually compress multiple ones of the different textures within the selected group.

Correspondingly, any textures within that selected group can then be (and in an embodiment are) decompressed using a single, same (second) neural network that is configured (trained) to perform texture decompression according to the second embodiment of the technology described herein.

In an embodiment, the selection of a group of graphics textures that are to be compressed using a single, same (first) neural network is performed such that a desired compression/decompression quality threshold and/or level of compression is met for all graphics textures within the selected group. For example, a desired compression/decompression quality threshold and/or level of compression may be defined in terms of any one or more of: (i) a size of the neural network (compared to the size of the individual neural networks for each texture in the group); (ii) a compressibility of the weights; (iii) a compression ratio; (iv) an accuracy (e.g. signal to noise ratio).

This selection can be done in various ways, as desired.

For instance, the selection of which different textures can or should be compressed using the same neural network may be based on various factors including, but not limited to, an expected texture similarity. In some cases this could be determined by a user (e.g. the application programmer). For example, different types of wood grain textures (e.g. pine, oak, etc.) might be expected to have a higher degree of similarity, and may thus compress well using the same neural network. However, in other embodiments, this selection may be performed automatically, e.g. as part of or prior to the compression process.

In some embodiments, this selection can be (and is) done by another neural network as part of the compression process.

Thus, in embodiments, for a set of (e.g. all) possible graphics textures that might be required for a particular graphics processing application, and that are therefore desired to be stored in a memory system in a compressed format, the set of possible graphics textures is in an embodiment first processed, in an embodiment using a suitably configured neural network, to identify one or more groups of multiple different textures that can and should be compressed using a same neural network.

This can work well since the neural network may be able to infer similarities between different graphics textures that may not otherwise be obviously apparent (e.g. to a human eye).

The selection could also be performed using similarities between the individual (separate) neural networks that may otherwise be used for compression the different textures in the group. In this respect, note that the different neural networks may typically be generated by a process of transfer learning, for example, where a base, pre-existing network is generated, and this is then fine-tuned for specific textures (or other output requirements, as desired). Thus, a number of layers of the neural network will be common to different neural networks. Analysing the different neural networks may therefore help identify candidate textures that can and should be compressed using a same neural network. For example, this could be done by first generating (e.g. by transfer learning, or otherwise), respective neural networks for different individual textures. The respective neural networks for the different individual textures can then be compared and based on a degree of similarity between the respective neural networks for the different individual textures, a group of multiple different textures that can and should be compressed using a same neural network can be identified. For example, if the respective neural networks for two different individual textures share a greater number of layers in common (e.g. compared to a set threshold), those two textures may then be identified as part of a group.

In other embodiments, the selection may (additionally/alternatively) be done iteratively. For example, an initial group of one or more textures may be identified (by any suitable means), and compressed using a particular neural network to meet a desired compression/decompression quality threshold and/or level of compression. A further one or more textures may then compressed using that same particular neural network, and provided that the desired compression/decompression quality threshold and/or level of compression is met, these further textures may also be added to the group. This process can continue until the desired compression/decompression quality threshold and/or level of compression is no longer maintained.

Various other examples would be possible for identifying different graphics textures that should be selected to be compressed using a single, same (first) neural network.

As mentioned above, an effect and benefit of having a single, same (first) neural network that is operable and configured to compress multiple different graphics textures is that a single, same (second) neural network can correspondingly be provided that is operable and configured to decompress any of those multiple different graphics textures. This can provide an improved graphics processor performance, e.g. in terms of reduced memory bandwidth and/or increased speed.

For example, in order to perform neural network based texture decompression, the graphics processor may first have to load in the appropriate, selected set of one or more neural networks to perform that neural network based texture decompression, based on the graphics texture data that is required to be processed and the desired format in which that graphics texture data is to be decompressed, etc., Thus, in response to the graphics processor programmable execution unit executing a “neural texturing” instruction, which “neural texturing” instruction causes the graphics processor to fetch certain graphics texture data from the (external) memory system in which it is stored, the graphics processor is in an embodiment operable to then load into the graphics processor, based on the graphics texture data that is the subject of the “neural texturing” instruction, a selected one or more neural network(s) for processing the fetched graphics texture data from a first, compressed format in which it is stored in the memory system to a second, uncompressed format for use by the graphics processor.

According to the technology described herein, however, the graphic processor is operable and configured to, prior to loading in the selected one or more neural network(s), check whether the required neural network(s) are already available locally to the graphics processor.

Thus, if the current texturing instruction relates to the same graphics texture data as a previous texturing instruction for which a selected one or more neural network(s) were previously loaded into the graphics processor, there is then no need to re-load the same neural network(s) into the graphics processor (as the required neural network(s) are already available locally to the graphics processor), and so this is in an embodiment avoided.

Further, by recognising, and selecting, groups of plural, different textures to be compressed (and hence decompressed) using the same neural network(s), the technology described herein can increase the possibility for re-using a neural network between different neural texturing requests as the same neural network(s) can be used for any individual textures within a particular group of plural different textures that have been selected to be compressed (/decompressed) using the neural network(s) in question. That is, selecting a group of plural different textures that are to be compressed using a same neural network can provide an improved graphics processor operation, in particular by reducing bandwidth associated with loading/re-loading neural network(s) between different neural texturing requests.

It is believed this operation of the graphics processor may be novel and advantageous in its own right.

Therefore, a third embodiment of the technology described herein comprises a method of operating a graphics processor,
the graphics processor comprising a programmable execution unit that is operable to execute programs to perform graphics processing,
the method comprising:
in response to the programmable execution unit executing a first neural texturing instruction that triggers neural network processing to process a first type of graphics texture data from a first, compressed format in which it is stored in memory to a second, uncompressed format for use by the graphics processor:
determining whether data for a first set of one or more selected neural networks for performing the desired neural network processing is stored locally to the graphics processor; and
when the first set of one or more selected neural networks is not stored locally to the graphics processor, the graphics processor loading data for the one or more selected neural networks into the graphics processor accordingly to perform the desired neural network processing;
the method further comprising:
the programmable execution unit subsequently executing a second neural texturing instruction that triggers execution of one or more selected neural networks to perform neural network processing to process a second, different type of graphics texture data, wherein the second, different type of graphics texture data is to be processed using the same first set of one or more selected neural networks that was used to process the first type of graphics texture data; and
the graphics processor using the same first set of one or more selected neural networks to process the second, different type of graphics texture data.

Thus, according to the third embodiment, to try to reduce bandwidth costs associated with loading in the selected neural network(s), the graphics processor is operable to try to re-use a neural network for different texturing requests once it has been loaded in. Thus, the graphics processor is operable to check when processing a neural texturing request whether the required neural network for performing that neural texturing request is stored locally to the graphics processor. If the required neural network is already stored locally to the graphics processor, it can then be used, e.g. immediately, without having to re-load data for that neural network into the graphics processor.

A similar check may be performed for the next neural texturing request, and so on (although in some cases it may already be known (e.g. identified by the compiler) that the same neural network can be used between multiple neural texturing requests in which case an explicit check may not be necessary).

For example, in embodiments, the graphics processor is associated with, or has access to, local storage in the form of a neural network buffer. The graphics processor is in an embodiment then operable to perform look ups to the neural network buffer so that if the neural network(s) required for a given texturing request is already stored locally in the neural network buffer, the neural network can be re-used (rather than re-loading the same neural network into the neural network buffer).

Thus, when a texturing request causes the graphics processor to fetch graphics texture data from the memory system, which graphics texture data is stored in the memory system in a first, compressed format, wherein the first, compressed format is a format in which neural network based texture decompression should be used to decompress the graphics texture data such that the neural network processing circuit should perform texture related neural network processing to process the graphics texture data from the first, compressed format in which it is stored in the memory system into a second, uncompressed format for use by the graphics processor:
it is in an embodiment determined whether the neural network or networks required for processing the fetched graphics texture data are already present in the neural network buffer; and
(only) when it is determined that the required neural network or networks are not already present in the neural network buffer, data for the required neural networks is loaded into the neural network buffer.

Thus, if multiple sequential texturing requests require the same neural network(s), the technology described herein in an embodiment facilitates re-using the neural network(s) between different texturing requests, thus in an embodiment avoiding unnecessarily re-loading the same neural network(s) into the graphics processor multiple times.

At some point during shader program execution a new texturing request may be made that requires data for a different neural network to be loaded into the graphics processor, and at that point the different neural network can be (and is) loaded in.

Thus, in embodiments, the programmable execution unit may subsequently execute a third (or further) neural texturing instruction that triggers execution of one or more selected neural networks to perform neural network processing to process a third (or further) type of graphics texture data that is different to the first and second types of graphics texture data, and that is to be processed using a different set of one or more selected neural networks to that used to process the first and second types of graphics texture data.

For instance, in that case, the checking whether first set of one or more selected neural networks is stored locally to the graphics processor will fail, and the graphics processor may then load in the different set of one or more selected neural networks for processing the third (or further) type of graphics texture data.

In some embodiments, this may be done immediately. However, it could be the case that another (e.g. the next) texturing instruction relates to a graphics texture that again is to be processed using the same first set of one or more selected neural networks that was used to process the first type of graphics texture data. In the worst case scenario, if texturing requests alternate between the first and third textures, for example, this could mean that the same sets of neural networks are repeatedly loaded in to the graphics processor.

In further embodiments, therefore, a texturing “parking” buffer (e.g. an additional/secondary buffer that is operable and configured to hold texturing requests) is provided that can be used to delay processing of texturing requests (i.e. to “hold” a texturing request temporarily) to try to increase the number of instances that a neural network can be re-used between different texturing requests.

Thus, in some embodiments, when it is determined that the required neural network or networks are not already present in the neural network buffer, prior to loading the required neural networks into the neural network buffer, the current texturing request is parked in such texturing parking buffer and the graphics processor attempts to process a subsequent texturing request. If the subsequent texturing request uses the neural network that is already stored locally, there is no need to (re-)load that neural network, and so the texturing request can proceed immediately (e.g. by loading in the required graphics texture, if needed, and then processing the graphics texture using the stored neural network).

On the other hand, if the subsequent texturing request also requires a different neural network to that which is already stored locally, this means that the different neural network needs to be loaded in before the subsequent texturing request proceeds. The subsequent texturing request could be held in the texturing parking buffer, and so on, with some suitable mechanism for eventually evicting texturing requests from the texturing parking buffer to ensure continued progress.

The texturing parking buffer in an embodiment has a finite, relatively smaller, number of entries (in some embodiments it has a single entry). Thus, if the texturing parking buffer is already full, the current texturing request may be actioned immediately.

Various other arrangements would be possible in this regard.

As will be explained further below, the texturing operations described above are in embodiments triggered by the graphics processor programmable execution unit executing a suitable (“neural texturing”) instruction included into a shader program that is currently being executed by the graphics processor programmable execution unit.

In embodiments, the compiler may also be able to identify instances where a same neural network can be used between different texturing requests within a single shader program, and to take this into account when generating the shader program. In particular, if the compiler can identify instances where a sequence of multiple texturing requests (for which neural texturing instructions are being included into the shader program) will require the same neural network or networks to be used, the compiler may be operable to (pre-)load the neural network(s) once, e.g. using a single neural network pre-load instruction that is included into the shader program in advance of the corresponding neural texturing instruction for the first texturing request in the sequence of texturing requests that will use the same neural network(s). Various arrangements would be possible in this regard for the compiler optimising the shader program execution.

The first and second embodiments of the technology described herein described above may therefore provide various benefits compared to other possible approaches, in particular in supporting the improved graphics processor operation according to the embodiment aspect of the technology described herein.

There are various other possibilities in this regard in terms of exploiting the increased configurability or flexibility that can be achieved using neural network based texture compression/decompression schemes.

For instance, a texturing request will typically specify a required level of detail. Neural network texture compression can be performed across multiple levels of detail (e.g. multiple mipmap levels). Thus, it may be possible to request multiple levels of detail from the same neural network, potentially in one go. Thus, in embodiments, the graphics texture data is provided at multiple different levels of detail, and the neural network when compressing a texture in the selected group of plural different textures is operable and configured to compress multiple different levels of detail of the texture, the first, compressed format thus storing multiple different graphics textures at multiple levels of detail. Correspondingly, when decompressing graphics texture data in such a first, compressed format that stores multiple levels of detail of graphics texture data, the neural network when decompressing one of the textures in the group of plural different textures is operable to output the texture data at a requested level of detail.

Similarly, a texturing request will typically specify a required number of channels of texture data. A benefit of neural network based texture compression schemes is that any number of channels can suitably be compressed together. Thus, in embodiments, the graphics texture data comprises plural channels of texture data, the plural channels including a set of colour and optionally transparency channels, and one or more additional channels, and the neural network when compressing a texture in the selected group of plural different textures is operable and configured to compress all of the plural channels of that graphics texture, the first, compressed format thus storing all channels of graphics textures. However, in some cases the required number of channels may be greater than the number of channels that are stored. In that situation, the or another neural network may be configured to generate the missing channels when performing the texture decompression. Thus, in embodiments, when a request is made for a greater number of channels of texture data than are stored for the first, compressed format, the or a neural network is operable and configured to generate any additional channels of texture data that have been requested.

As another example, as with more traditional (non-neural network based) texture decompression schemes, the output of the neural network based texture compression could have a fixed aspect ratio, with the texture mapping system (unit) then performing subsequent processing of the texture as needed to the desired aspect ratio for use. However, the neural network(s) that are used for the graphics texture decompression could, and in some embodiments are, configured (trained) to also output different aspect ratios. A desired aspect ratio may thus be specified in the texturing request, and this can then be (and in embodiments is) passed to the neural network processing unit and used to select an appropriate neural network (i.e., one that is configured to output the desired aspect ratio for the required texture at the desired level of detail, etc.) and/or as an input to the neural network processing to cause the neural network to output the required texture at the desired aspect ratio. Thus, in embodiments, the first, compressed format stores graphics texture data with a first aspect ratio, and the neural network when decompressing one of the textures in the group of plural different textures is operable to output the texture data at an aspect ratio other than the aspect ratio with which the graphics texture data is stored in the first, compressed format.

Similarly, rather than outputting a set of texel values that are then to be filtered (e.g. interpolated) by the texture mapping unit, in some embodiments, the neural network(s) that are used for the graphics texture decompression are configured (trained) to output filtered texture data. That is, in some embodiments, the neural network processing performs both decompression of graphics texture data and also filtering of the graphics texture data. That may then avoid the need for the texture mapping system to perform further texture filtering.

For instance, there is typically other than a direct correspondence between texture data elements and sampling positions. Thus, when performing texturing operations in respect of a particular sampling position, after fetching the graphics texture data into the graphics processor, and decompressing it as needed, it is often (and typically) necessary to perform one or more further processing operations to determine the best appearance that the sampling position should have, based on, e.g., the shape, size, angle, scale, etc. of the surface that is being texture mapped. These operations are typically referred to as texture “filtering” operations (and will also be referred to as such in the present application).

In more traditional graphics processors these texture filtering operations are often performed by a dedicated (hardware) texture filtering circuit that resides within the texture mapping system. This can often work well. However, texture filtering operations may become increasingly complicated (e.g. when performing anisotropic filtering) thus potentially requiring additional hardware circuitry (and associated silicon area) to be included to support all types of texture filtering (or else having to perform the texture filtering using general purpose compute shader operations, which may be less efficient). Thus, the present Applicants recognise that it may be beneficial to perform such texture filtering operations at least in part by neural network processing, alongside the neural network based texture decompression.

It is believed this operation in which the neural network processing performs both decompression of graphics texture data and also filtering of the graphics texture data may be novel and advantageous in its own right.

Therefore, a further embodiment of the technology described herein comprises a method of operating a graphics processor,
the graphics processor comprising a programmable execution unit that is operable to execute programs to perform graphics processing,
the method comprising:
in response to the programmable execution unit executing a first neural texturing instruction for obtaining graphics texture data at a specified level of detail for a specified sampling position within a render output:
the graphics processor fetching a block of graphics texture data containing graphics texture data at the specified sampling position into the graphics processor, wherein the block of graphics texture data is fetched into the graphics processor in a first, compressed format, wherein the block of graphics texture data in the first, compressed format includes data indicative of an array of texture data elements, and wherein there is other than a direct correspondence between the texture data elements and sampling positions so that one or more texture filtering operations should be performed to determine the appearance that the graphics texture should have at the specified sampling position; and
the graphics processor executing one or more neural networks to process the fetched block of graphics texture data to extract texture data representing a filtered texture value at the specified sampling position and level of detail in a second, uncompressed format for use by the graphics processor.

Thus, according to this further embodiment of the technology described herein, a texturing request triggers neural network processing that not only performs decompression of the graphics texture data from the first, compressed format in which it is stored in the memory system, and hence fetched into the graphics processor, but also performs at least in part the required texture filtering operations to (e.g.) interpolate between the texture data elements (texels) of the graphics texture and the sampling positions to which the texture is being applied. This then in an embodiment reduces the need for subsequent (hardware) texture filtering (and in some embodiments subsequent (hardware) texture filtering is omitted). In some embodiments, the texture filtering circuit (and an anisotropic texture filtering circuit) (hardware) can thus be omitted and all required texture filtering operations performed by executing appropriate neural networks. In that case, the filtered texture value output by the neural network processing may be provided directly to the programmable execution unit for continued processing.

As will be appreciated by those skilled in the art, this additional embodiment of the technology described herein can, and in an embodiment does, include any one or more or all of the features of the technology described herein described herein, as appropriate.

Thus, in addition to performing the decompression and texture filtering operations, the neural network processing according to this further embodiment may also, for example, output textures at different aspect ratios, or at multiple levels of detail, etc., For example, in an embodiment, the one or more neural networks are operable and configured to process the fetched block of graphics texture data to extract texture data representing the filtered texture value at the specified sampling position and level of detail and at a specified aspect ratio that is other than the aspect ratio in which the graphics texture data is provided in the first, compressed format. This can then provide further support for different texture processing (filtering) operations, such as anisotropic filtering, without requiring additional (hardware) texture filtering circuitry/circuits to be provided.

The texture filtering operations that are performed by the neural network processing according to this embodiment can be any suitable and desired (specified) texture filtering operations, depending on the graphics processing operation in question. For example, in embodiments, the one or more neural networks are operable and configured to perform bilinear filtering of texture data at a single level of detail. In other embodiments, the one or more neural networks are operable and configured to perform trilinear filtering of texture data across two levels of detail.

The neural network processing in this further embodiment may be performed in any suitable and desired manner. For example, a single, same neural network could be configured and trained to perform both the graphics texture decompression and the texture filtering operations, e.g. in one go. In other embodiments, however, a sequence of neural networks may be executed to do this. For example, a first neural network may be executed to perform the desired texture decompression into an initial, uncompressed format, and one or more further neural networks may then be executed to perform the desired texture filtering (e.g. interpolation) operations. Various arrangements would be possible in this regard.

The technology described herein may therefore provide various benefits compared to other possible approaches.

Thus, the present Applicants have found that there may be various benefits to using neural network based texture compression/decompression schemes in graphics processing applications. However, traditional graphics processors are not configured to support neural network based texture compression/decompression schemes, and so, despite these potential benefits, implementing neural network based texture compression/decompression schemes on more traditional graphics processors may be relatively inefficient.

Therefore, to facilitate the use of neural network based graphics texture compression/decompression schemes, the graphics processor according to the technology described herein is in an embodiment associated with, or has access to, a neural network processing circuit that is operable and configured to, when graphics texture data is fetched from the memory system in a first, compressed format in which the texture data has been compressed using a neural network based texture compression scheme, execute one or more neural networks to perform corresponding neural network processing (i.e. neural network decompression) to process the graphics texture data from the first, compressed format in which it is stored in the memory system to a second, uncompressed format for use by the graphics processor.

This can then provide more optimised support for neural network based texture compression/decompression schemes for graphics processing. For instance, the decompression of the graphics texture data could be done in software, e.g. by the graphics processor programmable execution unit executing a suitable compute shader program to perform the decompression, but this is not normally efficient. The use of such a dedicated (hardware) neural network processing circuit (that is separate to the programmable execution unit of the graphics processor) to perform the neural network processing for decompressing the compressed graphics texture data according to the technology described herein may therefore facilitate more efficient neural network decompression, e.g., and in particular, compared to attempting to perform the neural network based texture decompression with general purpose operations using the graphics processor programmable execution unit.

Subject to the particular requirements of the technology described herein, the neural network processing circuit may otherwise be configured and provided in any suitable and desired manner.

Similarly, the neural network processing circuit may in principle be (logically) located at any suitable and desired point within the graphics processing system.

In an embodiment, however, the neural network processing circuit is local to and on-chip with the graphics processor.

In an embodiment, the graphics processor comprises a plurality of shader (processing) cores, each shader (processing) core having its own programmable execution unit and its own respective neural network processing circuit (and in an embodiment also its own texture mapping system, where one is provided). Thus, in embodiments, the texture compression is performed locally to, and “on chip” with, the graphics processor shader (processing) cores (e.g. rather than within a resource that is shared between all of the shader (processing) cores, or otherwise external to the shader (processing) cores).

Various arrangements would however be possible in this regard for providing such a neural network processing circuit.

For example, in some embodiments, the neural network processing circuit may be dedicated for performing neural network texture decompression (e.g., and therefore not available for any other neural network processing).

In that case, the neural network processing circuit may be associated with, and in an embodiment local to (on-chip with), the texture mapping system (where one is provided) such that the neural network processing circuit is located along the same memory access path that normally handles texturing requests. Thus, in in a similar manner that the texture mapping system may be associated with, or have access to, various texture decompression hardware circuits for performing more traditional, i.e. non-neural network based, texture decompression, the texture mapping system may also (or instead) be associated with, or have access to, one or more neural network processing circuits dedicated for performing the neural network based texture decompression according to the technology described herein.

Where the neural network processing circuit is associated with the texture mapping system, the texture mapping system should, and in an embodiment does, also have access to the memory system in which the neural networks are stored so that data for the required neural network(s) can be loaded in to a suitable neural network buffer as required to perform the neural network based texture decompression (as will be explained further below).

Where the neural network processing circuit is provided within the texture mapping system it may be provided at any suitable (logical) position within the texture mapping system. For example, and in an embodiment, it is provided within a texture cache system of the texture mapping system (similarly to other texture decompression hardware circuits that may be provided), and in an embodiment it is configured to perform the neural network based texture decompression as and when texture data is fetched into the texel cache that interfaces with the texture mapping unit of the texture mapping system. However, various other arrangements would be possible, e.g. depending on the arrangement of the texture mapping system in question.

Providing the neural network processing circuit as part of the texture mapping system may then simplify the messaging that is required, and can make relatively efficient use of the texture mapping system's other, existing circuitry, as the neural network based texture decompression can be performed similarly to other texture decompression that may be performed within the texture mapping system, as the neural network processing circuit is effectively another decompression hardware circuit that can be used/triggered in a similar fashion. However, providing such a neural processing circuit to the texture mapping system of course involves additional silicon area cost as such neural network processing circuit would not otherwise be provided within the texture mapping system (e.g. in a more traditional graphics processor that did not support neural network based texture compression/decompression schemes).

In an embodiment, therefore, the neural network processing circuit is a neural network processing circuit that is also available to perform other neural network processing. That is, in embodiments, an existing neural network processing circuit (that is separate to the texture mapping system or any other circuitry that would normally handle texturing requests) is effectively re-purposed to also perform the neural network based texture decompression, when required.

The effect and benefit of this is that neural network based texture compression/decompression can then be supported using a neural network processing circuit that is also available to perform other, non-texture related neural network processing, and that therefore has other uses, such that any increase in silicon area is mitigated (thereby reducing cost, and potentially energy consumption). That is, there may also be benefits in providing such a neural network processing circuit to support other types of neural network processing work, such that it may already be desirable to provide such a neural network processing circuit, and this (existing) neural network processing circuit can then also be used for supporting the neural network based texture compression/decompression of the technology described herein without significant further increase in silicon area (e.g. compared to the area cost for providing such neural network processing circuit in the first place).

Thus, in embodiments, in addition to perform the texture related neural network processing of the technology described herein, the neural network processing circuit is also operable to perform other, non-texture related neural network processing for the graphics processor.

As will be explained further below, the neural network processing circuit may thus have multiple sources of neural network processing work for which it may be controlled to perform neural network processing for, and may thus have one or more job control interfaces that allow different types of neural network processing tasks to be scheduled onto the neural network processing circuit, as desired.

Various arrangements would be possible in this regard for providing such neural network processing circuit and controlling the scheduling of neural network processing work to the same.

The control of the neural network processing circuit to perform neural network texture decompression when required can be achieved in various suitable and desired ways, e.g. depending on the arrangement of the neural network processing circuit.

For example, in the embodiment, where the neural network processing circuit is also available to perform other, non-texture related neural network processing for the graphics processor, the graphics processor may comprise a suitable neural endpoint that is operable and configured to schedule neural network processing tasks to the neural network processing circuit (and which neural endpoint is in an embodiment separate to the fragment shader endpoint that schedules fragment shader tasks to the programmable execution unit). Thus, a job controller for the graphics processor, when neural network processing is desired to be performed, may be operable and configured to schedule a suitable one or more neural network processing tasks to be performed by the neural network processing circuit and send these to the neural endpoint.

In some embodiments, therefore, when neural network based texture decompression is to be performed, this could be handled using the normal job control for the neural network processing circuit, i.e., by the job controller scheduling suitable neural network processing tasks to be performed and sending these to the (same) neural endpoint that handles the scheduling of all neural network processing tasks to be performed by the neural network processing circuit.

This may not, however, be very efficient for handling texturing requests, especially given the relative frequency at which texturing requests may be received. For instance, in that case, a texturing request for which neural network processing is required, may be initiated by the programmable execution unit executing a suitable texturing instruction, with this instruction then causing the required neural network processing tasks to be sent to the neural endpoint, but this has to be done by going back through the job controller. Further, when the neural network processing has been performed, further processing (e.g. texture filtering, etc.) may need to be performed by the texture mapping system, requiring additional instructions and messaging between the programmable execution unit and texture mapping system.

In an embodiment, therefore, the graphics processor programmable execution unit can directly message the neural network processing circuit. That is, in embodiments, an additional messaging/control interface is provided between the programmable execution unit and the neural network processing circuit such that the programmable execution unit can directly trigger neural network processing operations without having to go back through separate job control.

In further embodiments, the graphics processor texture mapping system (i.e., the system that handles the texturing requests made by the graphics processor programmable execution unit) is (also) operable to exchange messages with the neural network processing circuit. Thus, in an embodiment, an additional (new) messaging/control interface is provided between the texture mapping system and the (separate) neural processing circuit (which interface would not otherwise be present as such interface would not generally be needed for any other, non-texture related neural network processing that the neural processing circuit is operable to perform).

That is, the present Applicants have recognised that it may be particularly advantageous to be able to (re-) use such a neural processing circuit that is already available to perform other (non-texture related) neural network processing to support neural network based texture compression/decompression.

The present Applicants further recognise that to support such neural texturing operations it is then beneficial to provide additional dedicated interfaces to allow the programmable execution unit and/or texture mapping system to directly exchange messages with the neural processing circuit (e.g. rather than using the normal job control/scheduling for the existing neural network processing circuit as the present Applicants have recognised that this may be relatively inefficient for handling neural texturing operations). This can then provide an overall more efficient (e.g. in terms of both performance and silicon area) approach for supporting neural network based texture decompression “on chip”.

In such cases, the messaging to control the obtaining of the required graphics texture data and causing the neural network processing circuit to perform the required neural network based texturing operations to process graphics texture data from the first, compressed format in which it is stored in the memory system to the second, uncompressed format for use by the graphics processor may then be performed in various different ways.

For example, in some embodiments, any texturing requests that require neural network processing to be performed are initially sent from the programmable execution unit to a texture mapping system of the graphics processor (e.g. in the same way that traditional, i.e. non-neural, texturing requests would be).

In particular, as described above, the graphics processor may, and in an embodiment does, include a texture mapping system that is operable to manage requests from the programmable execution unit for graphics texture data.

Thus, in response to the programmable execution unit executing an instruction to perform a texturing operation for which neural network processing should be performed (i.e. a “neural texturing” instruction), the programmable execution unit in one embodiment then messages the texture mapping system to request the required graphics texture data.

In an embodiment, the texture mapping system then checks whether the required graphics texture data (i.e. at the requested sample co-ordinates) is already available within local storage of the graphics processor, e.g. since it has been fetched in due to a previous texturing request. This local storage may be any suitable local storage available for this purpose.

For example, in some embodiments, graphics texture data may be fetched in via the texture cache system, and stored in a cache within the texture cache system. That is, in some embodiments, the local storage is local storage that is specifically (already) provided for storing graphics texture data. In that case, the fetching in of the graphics texture data is in an embodiment then performed as normal, and in the same manner regardless of whether the graphics texture data has been compressed using a neural network based texture compression scheme or otherwise. The texture mapping system checking whether the required graphics texture data is already available within local storage of the graphics processor may thus comprise performing a look up to the texture cache system.

In that case, if the required graphics texture data is not already available in the local storage (the texture cache system), the graphics texture data is then fetched in via the texture cache system, e.g. as normal, but the texture mapping system may then message the neural network processing circuit to cause the neural network processing circuit to perform the required neural network processing to process the fetched graphics texture data from the first, compressed format in which it was stored in the memory system into the desired second, uncompressed format for use by the graphics processor.

To do this, the neural network processing circuit may be operable to read graphics texture data from the texture cache system into its local storage to perform the neural network processing (and correspondingly, once it has finished its processing, to write the processed graphics texture data back to the texture cache system). Other arrangements would however be possible.

For example, as alluded to above, the neural network processing circuit may, and in an embodiment does, also have its own local storage (a “neural texture” cache) for storing graphics texture data. In that case, graphics texture data for which neural network processing is required could be fetched in directly to the neural network processing circuit (rather than via the texture cache system).

In some embodiments, therefore, rather than the texture mapping system checking its own local storage (i.e. the texture cache system) to see whether the required graphics texture data is already stored locally, the texture mapping system messages the neural network processing circuit to cause the neural network processing circuit to check its own local storage (the “neural texture” cache), and to fetch the required graphics texture data in (and process it), as needed, e.g. if it is not already stored locally.

Thus, in some embodiments, the initial texturing request is sent to the texture mapping system, and processed thereby, with the texture mapping system messaging the neural network processing circuit to trigger the neural network processing circuit's processing of any graphics texture data that is fetched in from the memory system. Thus, in the situation where the initial texturing requests causes the required graphics texture data to be fetched in from the memory system (i.e., since it is not already stored locally), the neural network processing circuit is caused to perform neural network processing to process the fetched graphics texture data from the first, compressed format to the second, uncompressed format for use by the graphics processor, and this processing is triggered by the texture mapping system messaging the neural network processing circuit (which message could be a message to perform the processing or could be a message to tell the neural network processing circuit to first check whether it already has the required graphics texture data stored locally, etc., as discussed above).

Thus, in embodiments, an interface is provided between the texture mapping system and the neural network processing circuit such that the texture mapping system is operable to exchange messages with the neural network processing circuit, and the texture mapping system exchanges messages with the neural network processing circuit to control the processing of graphics texture data from the first, compressed format in which it is stored in the memory system into a second, uncompressed format for use by the graphics processor, as required.

Once the neural network processing circuit has processed the graphics texture data, the graphics texture data in the second, uncompressed format is in an embodiment then returned to the texture mapping system, with the texture mapping system then performing any desired further processing (e.g. texture filtering) before returning the requested texture data to the programmable execution unit.

It may however also be possible for the neural network processing circuit to return the requested texture data directly to the programmable execution unit (for example, this may be appropriate if the neural network processing also performs texture filtering, as contemplated above).

Various arrangements would be possible in this regard.

Thus, in the embodiment described above, any texturing requests that require neural network processing to be performed are initially send to the texture mapping system, with the texture mapping system then messaging the neural network processing circuit, as required, to obtain and process the required graphics texture data. In other embodiments, any texturing requests that require neural network processing to be performed may be initially sent directly to the neural network processing circuit.

In that case, in response to the programmable execution unit executing an instruction to perform a texturing operation for which neural network processing should be performed, the programmable execution unit in an embodiment messages the neural network processing circuit to request the required graphics texture data. The neural network processing circuit in an embodiment then checks whether the required graphics texture data is already stored locally. If not, the neural network processing circuit in an embodiment then causes the required graphics texture data to be fetched in from the memory system to local storage associated with the neural network processing circuit, and the neural network processing circuit processes the fetched graphics texture data from the first, compressed format to the second, uncompressed format for use by the graphics processor.

In such embodiments, the neural network processing circuit in an embodiment then passes the graphics texture data in the second, uncompressed format to the texture mapping system of the graphics processor for further processing (e.g., texture filtering, etc., similarly as described above), with the texture mapping system then provided the required graphics texture data to the programmable execution unit once it has finished its further processing. However, it would also be possible for the neural network processing circuit to pass the graphics texture data in the second, uncompressed format directly to the programmable execution unit, (with the graphics texture then being used directly by the programmable execution unit, or being passed to the texture mapping system, as desired).

Various other arrangements would be possible for scheduling and dividing neural network based texture processing between the texture mapping system and the neural network processing circuit and as benefit of the technology described herein at least in its embodiments is to allow increased flexibility and configurability in this regard by providing additional messaging/control interfaces that facilitate such scheduling and division of neural network based texture processing between the texture mapping system and the neural network processing circuit.

The neural network processing that is performed when processing graphics texture data from the first, compressed format in which it is stored in the memory system to the second, uncompressed format for use by the graphics processor may comprise any suitable and desired processing operations. Further, the neural network processing may be performed for some or all of the graphics texture data that is fetched from memory. That is, a given neural texturing job that is executed by a neural network processing circuit may generally any suitable portion of graphics texture data (and the processing of the graphics texture data could, for example, be divided between multiple neural texturing jobs, if desired).

In fact, a particular effect and benefit of using the neural network based texture compression/decompression schemes of the technology described herein is that this then offers increased flexibility and configurability as to how the graphics texture data is processed (whereas traditional texture compression schemes are typically relatively constrained by what is supported in the respective hardware decompression circuits).

Various examples are contemplated in this respect, as discussed above.

Thus, a texturing request may specify one or more, and optionally all, of a desired texture (type/content), a desired texture channel, a desired level of detail, a desired aspect ratio, whether or not filtering should be performed, etc., and this specification may be used by the neural network processing circuit to select (and load data for) an appropriate one or more neural networks to return the specified, desired graphics texture data and/or as inputs to the selected neural network(s) to cause the selected neural network(s) to perform neural network processing operations to return the specified, desired graphics texture data.

It will be appreciated that this enhanced configurability is a significant benefit of neural network based texture compression/decompression schemes.

Further, the technology described herein allows any and all such neural network based texture compression/decompression schemes to be supported by the same neural network processing circuit, since the neural network processing circuit can load in the appropriate (correct) neural network or networks to perform the desired processing, whatever that is, and then perform the desired processing accordingly. Thus, in the technology described herein, these benefits are achieved without significant further increase in silicon area since once the neural network processing circuit is provided, it can then be configured to perform any desired neural network processing by loading in the appropriate neural networks.

The neural networks may generally be configured to perform the desired neural network processing in any suitable manner. Typically this will be done through training of the neural networks, in an embodiment in a supervised manner. In embodiments, the training may comprise transfer learning, where a base model is generated and then transfer learning is performed to tune that base model for different output requirements (e.g. different textures, etc., as discussed above), but various arrangements would of course be possible in this regard. Thus, a given neural network can be trained to provide whatever outputs are desired based on an input set of (compressed) graphics texture data. Likewise, multiple neural networks may be used together to extend the range of outputs. Similarly, any suitable neural network architecture (models) may be used. For example, in some embodiments, the neural network(s) may comprise multi-layer perceptrons, such as convolutional neural networks. However, other neural network architecture (models) may also be suitably used.

In an embodiment, and optionally in addition to any local storage that may be used for storing graphics texture, the neural network processing circuit is also associated with a neural network buffer for storing data for one or more neural networks (i.e. a model, and its associated weights, etc., defining the neural network, or part thereof) for performing the neural network processing. In order to perform neural network based texture processing, the graphics processor is thus in an embodiment operable to load in data for one or more selected neural networks to such neural network buffer so that the neural network processing circuit can then execute the selected neural networks to perform the desired texture related neural network processing.

It will be appreciated here that loading in data for a neural network may involve loading in a neural network ‘in full’ (i.e. loading in all data, such as weights, etc., required to execute the neural network). However, this is not necessarily the case and in some embodiments the data that is loaded in for storing in the neural network buffer may be less than the ‘full’ neural network. For example, it could be the case that the neural network processing is performed as a number of smaller neural tasks, each of which executes part of the neural network processing (representing a portion of the ‘full’ neural network).

An example of this might be performing sequences of operations for neural network processing on a block-by-block basis, e.g. as described in United States Patent Application No. 2023/0186045 (Arm Limited), the entire content of which is incorporated herein by reference. This may be particularly useful for reducing the amount of neural network data that needs to be loaded in at any particular instant. In that case, the data that is loaded in may be the data for a particular neural task which may be some or all of the data for the ‘full’ neural network.

Accordingly, according to embodiments, the neural network processing may be executed as a plurality of smaller neural tasks, and the data for each neural task may be fetched (i.e. stored in the neural network buffer), processed, and output (in an embodiment to an internal buffer) separately.

It could also be the case, e.g., and in particular, when transfer learning is applied, that the different neural networks may be generated from a same, base neural network such that the different neural networks may each comprise a set of one or more layers that is common to the different neural networks and a set of one or more layers that is specific to that particular neural network. In that case, the common layers may already be stored locally and the data that is to be loaded in may comprise only the layers that are specific to the particular neural network that is required.

Various arrangements would be possible in this regard.

Thus, in general, the graphics processor may load in to the neural network buffer any suitable and required data for the neural network or neural networks that are to be executed (and this data may be less than all of the data defining the neural network ‘in full’).

As mentioned above, in embodiments, the neural network processing circuit is also operable to perform other, non-texture related neural network processing. That is, in embodiments, although the neural network processing circuit is accessible by the texture mapping system, the neural network processing circuit is separate to the texture mapping system, and may have other (separate) control interfaces to those used for handling neural texturing requests, such that the neural network processing is also usable for other, non-texture related neural network processing.

For example, there are various other applications of neural networks in graphics processing including, but not limited, to so-called “super sampling” and/or other “anti-aliasing” techniques or “de-noising” when performing ray tracing processes, and the (same) neural network processing circuit may, and in embodiments does, also support such other neural network processing. The neural network processing circuit may also be used to perform other neural network processing for non-graphics processing applications, if desired.

Thus, in addition to the control discussed above (e.g. where the programmable execution unit and/or texture mapping system are operable to message the neural network processing circuit to perform texture related neural network processing in response to a texturing instruction being executed that causes graphics texture data to be fetched in from the memory system for which neural network based texture processing (decompression) is to be performed), the neural network processing circuit may therefore have one or more other sources of neural network processing work, and correspondingly may have other control interfaces, for which it may be triggered to perform neural network processing. This, however, means that the neural network processing circuit may be busy with such other, non-texture related neural network processing at the point at which it is desired to perform neural network based texture processing.

Thus, in embodiments, the neural network processing circuit is also operable to perform other, non-texture related neural network processing for the graphics processor, the neural network processing circuit thus having a job controller that is operable to schedule such other, non-texture related neural network processing to be performed by neural network processing circuit.

This means that different sources of neural network processing work may compete for use of the neural network processing circuit. In an embodiment, a mechanism is therefore provided to arbitrate between different neural network processing tasks that may be provided to the neural network processing circuit from different sources of neural network processing work, e.g. based on relative priorities that can be assigned to the different neural network processing tasks.

In particular, the graphics processor may be operable to block other, non-texture related neural network processing being performed by the neural network processing circuit, when required, to allow the neural network processing circuit to perform texture related neural network processing (and vice versa) (if that is desired, e.g. based on the relative priorities between texturing/non-texturing related neural network processing tasks). This then allows controlling scheduling of texture related neural network processing tasks and other, non-texture related neural network processing tasks.

Thus, the neural network processing circuit may be able to arbitrate between texture related neural network processing tasks and other, non-texture related neural network processing tasks based on relative priorities. When texture related neural network processing tasks have a higher priority, the neural network processing circuit may therefore block or interrupt any other, non-texture related neural network processing in order to prioritise the texture related neural network processing tasks.

This arbitration/scheduling can be done in various suitable ways. For example, if neural texturing tasks are given priority, any messages from the programmable execution unit and/or texture mapping system to the neural network processing circuit to perform texture related neural network processing may automatically interrupt or block any other neural network processing that is being performed. Alternatively/additionally, a job controller for the neural network processing circuit may be able to determine what type of task the neural network processing circuit is currently performing and then implement a suitable block or interrupt, as needed. When processing is interrupted, the interrupt may be implemented in any suitable manner, for example, optionally using a suspend mechanism that allows the current task to be subsequently resumed, if that is desired.

In typical graphics processing applications it is expected that neural texturing operations may not often overlap with other neural network processing within the same processing job (for example, ray tracing de-noising will typically not be performed closely to texturing operations within a particular processing job), such that in many cases the same neural network processing circuit can be used to perform all neural network processing with relatively few instances of competing requests to the neural network processing circuit within the same processing job.

Various other arrangements would be possible in this regard for scheduling tasks to the neural network processing circuit.

For example, and typically, a graphics processor will be arranged as a plurality of separate shader (processing) cores, each shader (processing) core having its own programmable execution unit. In that case, as mentioned above, each shader (processing) core in an embodiment also has its own respective neural network processing circuit (and its own respective texture mapping unit, texture cache system, etc., in the normal manner for such arrangements). Texturing requests, including requests for neural network based texture processing, are therefore typically (and normally) handled by the respective circuitry, i.e. the texture mapping system and/or neural network processing circuit, associated with the same shader (processing) core as the programmable execution unit that is making the texturing request.

Thus, provided that a neural network processing circuit on a given shader (processing) core is available, any requests for neural network based texture processing originating from the programmable execution unit on that shader (processing) core will be processed by that neural network processing circuit. However, if the neural network processing circuit is not available to perform neural network based texture processing (e.g. because it is busy performing other neural network processing), in some embodiments, the graphics processor may be able (and may) send the neural network based texture processing to a neural network processing circuit on another shader (processing) core, where one is available.

Accordingly, in embodiments, the graphics processor is arranged as plural shader (processing) cores, wherein a respective shader (processing) core may have its own programmable execution unit and respective neural network processing circuit. An overall job controller for the graphics processor may therefore try to schedule jobs including neural texturing instructions to shader (processing) cores that are able to perform the texture related neural network processing, e.g. based on the capacity/loading of the shader (processing) cores. However, in some cases, such jobs may still be scheduled to a shader (processing) core that is not (currently) able to perform the required texture related neural network processing. In some cases, the texture related neural network processing may therefore need to wait. However, it may also be possible for the shader (processing) core to cancel the job so that it can be issued to another shader (processing) core, or request that part of the job (i.e. the part requiring the texture related neural network processing) is performed by another shader (processing) core. Various options would be possible in this regard.

Thus, in embodiments, when the programmable execution unit of a particular shader (processing) core requires texture related neural network processing to be performed in respect of graphics texture data that has been fetched from the memory system, when there is no neural network processing circuit associated with that programmable execution unit available to perform the required texture related neural network processing (e.g. because the respective neural network processing circuit associated with that programmable execution unit is busy, or otherwise unavailable (e.g. it has been powered down)), the graphics processor may attempt to perform the texture related neural network processing using the neural network processing circuit of another shader (processing) core, if one is available. In that case, the shader (processing) core that cannot perform the required texture related neural network processing may send a message back to the overall job controller for the graphics processor with the texturing instruction to be executed and the overall job controller for the graphics processor can then select a different shader (processing) core to execute the texturing instruction (with the results then being returned to the original shader (processing) core via the overall job controller for the graphics processor). Alternatively, a shader (processing) core may be able to signal immediately to the overall job controller for the graphics processor that it cannot (currently) execute the entire task that includes the texturing instruction, and request that the task is cancelled, such that the overall job controller for the graphics processor can then select a different shader (processing) core to execute the task.

Various arrangements would be possible in this regard.

Subject to the particular requirements of the technology described herein, the texturing operations described above can be triggered and performed in any suitable and desired way.

For example, and in embodiments, the texturing operations described above are triggered by the graphics processor programmable execution unit executing a suitable (“neural texturing”) instruction included into a shader program that is currently being executed by the graphics processor programmable execution unit.

Thus, the operation of the technology described herein is in an embodiment triggered by including appropriate instructions into a graphics processing shader program.

Such instructions can be included in a shader program to be executed by the programmable execution unit in any suitable and desired manner and by any suitable and desired element of the overall data (graphics) processing system, e.g. depending on how the shader programs are generated.

In an embodiment, it or they is generated by a compiler (the shader compiler) for the graphics processor of the graphics processing system in question (and thus the processing circuit that generates the shading program in an embodiment comprises an appropriate compiler circuit). The compiler is in an embodiment executed on an appropriate programmable processing circuit of the graphics processing system.

The compilation process (the compiler) can generate the shader program in any suitable and desired manner, e.g., and in an embodiment, using any suitable and desired compiler techniques for that purpose.

Thus, in embodiments, one or more “neural texturing” instructions can be (and are) included in a shader program that is to be executed by the graphics processor by the compiler in response to an appropriate indication that a set of texturing operations are to be performed using graphics texture data that has been compressed for storage in the memory system using neural network based texture compression.

Thus, e.g., and in an embodiment, an application program will be able to include an explicit indication of a need for a set of one or more texturing operations to be performed, with the compiler then, in the technology described herein, including an appropriate one or more “neural texturing” instructions in the compiled shader program in response to that indication, as required. It may also be possible for the compiler to include an appropriate one or more “neural texturing” instructions of its own accord, e.g. in the case where the compiler is able to assess the shader program being compiled to identify when and where to include such instructions, even in the absence of an explicit indication of that.

In an embodiment, the compiler analyses the shader program code that is provided, e.g. by the application on the host processor that requires the graphics processing, and includes an appropriate one or more “neural texturing” instructions at the appropriate point(s) in the shader program (e.g. by inserting the instruction(s) in the (compiled) shader program).

The technology described herein also extends to and includes such operation of a compiler.

Another embodiment of the technology described herein thus comprises a method of compiling a shader program to be executed by a programmable execution unit of a graphics processor that is operable to execute graphics processing programs to perform graphics processing operations, the method comprising:
when compiling a shader program to be executed by a programmable execution unit of a graphics processor to perform a graphics processing operation that requires graphics texture data that is stored in memory in a first, compressed format, wherein the first, compressed format is a format in which neural network based texture compression has been used to compress the graphics texture data:
selecting, based on the graphics texture data that is required, from a plurality of available neural networks, a corresponding one or more neural networks that are to be executed to process the required graphics texture data from the first, compressed format into a second, uncompressed format for use by the graphics processor; and
including into the shader program a set of one or more neural texturing instructions that when executed as part of the shader program will cause the graphics processor to obtain the required graphics texture data and, when the required graphics texture data is fetched in from memory such that is needs to be processed from the first, compressed format in which it is stored in the memory into the second, uncompressed format for use by the graphics processor, to process the required graphics texture data into the second, uncompressed format using the selected one or more neural networks.

The set of one or more neural texturing instructions in an embodiment also causes the graphics processor to load the selected one or more neural networks into the graphics processor (e.g. into a neural network buffer associated with, and/or accessible to, the neural network processing circuit). Thus, if the selected one or more neural networks are not already loaded into the graphics processor when the neural network based texture processing is to be performed, this is in an embodiment triggered by and in response to execution of the set of one or more neural texturing instructions.

The compiler (compilation process) may alternatively or additionally include into the shader program one or more instructions for ‘pre-loading’ any desired graphics texture data and/or neural networks into graphics processor local storage, where it is possible to do so. Thus, the loading of the selected one or more neural networks may be, and in some embodiments is, triggered by and in response to execution of such instructions for pre-loading the neural networks.

The compiler (the compiler processing circuit) is in an embodiment part of, and in an embodiment executes on, a central processing unit (CPU), such as a host processor, of the graphics processing system, and is in an embodiment part of a driver for the graphics processor that is executing on the CPU (e.g. host processor).

In this case, the compiler and compiled code will run on separate processors within the overall graphics processing system. However, other arrangements would be possible, such as the compiler running on the same processor as the compiled code, if desired.

The compilation process (the compiler) can generate the shader program in any suitable and desired manner, e.g., and in an embodiment, using any suitable and desired compiler techniques for that purpose.

Thus, in an embodiment, the shader program is generated by the compiler, and the compiler is arranged to include within the shader program the instructions that are used in the technology described herein. Other arrangements would, of course, be possible.

The generated shader program can then be issued to the programmable execution unit of the graphics processor for execution thereby.

The technology described herein also extends to the operation of the graphics processor itself when executing the shader program.

Thus, in embodiments, there is provided a method of operating a graphics processor, the method comprising:
when the graphics processor programmable execution unit is executing a shader program:
in response to the graphics processor programmable execution unit executing a “neural texturing” instruction that is included in the shader program:
triggering the operation according to the technology described herein in any of its embodiments.

Thus, executing the “neural texturing” instruction in an embodiment triggers the graphics processor programmable execution unit to send a message (a texturing request) to the neural network processing circuit and/or texture mapping system of the graphics processor in order to obtain and process the required graphics texture data, e.g. as described above.

As will be appreciated by those skilled in the art, these additional embodiments of the technology described herein relating to the operation of the compiler and/or the graphics processor can, and in an embodiment do, include any one or more or all of the features of the technology described herein described herein, as appropriate.

Various other arrangements would however be possible for triggering the particular texturing operations according to the technology described herein.

The texturing operations may otherwise be performed in any suitable and desired manner, e.g. in the normal manner for graphics processor texturing operations.

For example, once the graphics texture data has been fetched, and processed into a suitable uncompressed format, as needed, however this is done, further processing of the graphics texture data may then be (and in an embodiment is) performed before returning the graphics texture data (i.e. a texturing response) to the programmable execution unit. For instance, this further processing may, and typically will, include performing any desired filtering/interpolation of the fetched graphics texture data. This filtering/interpolation can be, and in an embodiment is, done by the texturing mapping system, e.g. in the normal manner of operation of such texturing mapping systems.

As discussed in detail above, according to the technology described herein, at least some graphics texture data stored in the memory system is compressed using a neural network based compression scheme. In some embodiments, all of the graphics texture data is compressed using neural network based compression and stored thus stored in the memory system in a consistent, compressed format.

In general, however, the memory system may store various graphics texture data that has been compressed in a plurality of different ways (e.g. using various different neural network and/or non-neural network based texture compression schemes) and the graphics processing system should be, and in an embodiment is, configured to support such a plurality of different types of compressed data.

In an embodiment, therefore, in addition to the neural network processing circuit that is operable and configured to perform the neural network texture decompression (e.g. as described above), the graphics processing system further comprises one or more additional (hardware) texture decompression circuits that are in an embodiment configured for decompressing texture data that has been compressed using a different, non-neural network based texture compression scheme. For example, the graphics processor may, and in some embodiments does, include, in an embodiment within the texture mapping system, at least a decompression circuit that is configured to decompress texture data that is compressed using Arm's adaptive scalable texture compression (ASTC) technique, e.g. as described in U.S. Pat. No. 9,058,637 (Arm Limited). Various arrangements would be possible in this regard.

Where graphics texture data can be (and is) stored in the memory system using a number of different texture compression schemes, including both neural network based and non-neural network based texture compression schemes, any texturing requests relating to texture data that has been compressed using a traditional, non-neural network based texture compression scheme can be, and in an embodiment are, handled as normal, e.g. by the texture mapping system. A shader program may thus include a number of ‘normal’ texturing instructions and/or a number of “neural texturing” instructions, and these can be handled appropriately (differently) by the graphics processor.

Subject to the particular requirements of the technology described herein, the neural network processing circuit may generally take any suitable and desired form.

The neural network processing circuit of the graphics processor may be, and is in an embodiment, a (substantially) fixed-function hardware unit (circuit) that is configured to perform processing operations for neural network processing tasks. The neural network processing circuit should thus comprise an appropriate fixed function circuit or circuits to perform the required operations, although it may comprise and have some limited form of configurability, in use, e.g. if desired.

The neural network processing circuit is in embodiments configured to perform arithmetic operations, such as, and in an embodiment, multiply-and-accumulate (MAC) operations. The neural network processing circuit thus in an embodiment comprises one or more MAC circuits that are configured to perform such operations.

Thus, the neural network processing circuit may load in an input feature map (e.g. representing a block of graphics texture data in a first, compressed format), together with a set of weights, biases, etc., from respective buffers (in general, ‘storage’, which storage may be integral with the neural network processing circuit or may be located elsewhere in the graphics processor (shader (processing) core) (e.g. the shader core level 1 (L1) cache, tile buffer, etc.) and accessed by the neural network processing circuit, various arrangements being possible in this regard (for example, as alluded to above, the neural network processing circuit may itself store the graphics texture data locally, but it may also in some embodiments load the graphics texture data from a texture cache system that is part of a texture mapping system of the graphics processor).

Once the input feature map is loaded in, the neural network processing circuit may then perform the required arithmetic (e.g. MAC) operations to executed the selected neural network(s) generate the corresponding output feature map, and then write the output feature map (the graphics texture data in the second, uncompressed format) into a suitable buffer. Various arrangements would be possible in this regard.

As already mentioned above, the neural network processing circuit thus in an embodiment also has access to one or more buffers for storing data that may be required for neural network processing operations. These buffers may be integral to the neural network processing circuit, or may be otherwise located within the graphics processor (shader (processing) core) but accessibly by the neural network processing circuit and available to store data for neural network processing operations. For instance, neural network processing typically involves input data at least in the form of an input feature map, output data in the form of an output feature map, the weights that are to be applied, as well as any other control information (data structures, programs, etc.) that determine the processing operations to be performed, and this data therefore needs to be loaded in and at least temporarily stored for use by the graphics processor when performing the neural network task (and this also applies for the neural network based texture processing of the technology described herein).

Thus, in embodiments, the neural network processing circuit has an interface to a memory system of the graphics processor where such data resides. For instance, in embodiments the graphics processor is in communication with external, e.g. main, memory.

In some embodiments, the graphics processor has one or more external memory access interface that is common for all types of data that may need to be transferred between the graphics processor and the external memory. That is, all memory requests (whether for graphics processing work or neural network processing work) are in an embodiment made via the same, shared memory interface, in an embodiment via a shared cache system. For instance, the graphics processor in an embodiment comprises a cache (or arrangement of plural caches) that is local to the graphics processor, e.g. one or more level 2 (L2) cache, via which data can be transferred to/from external memory, and this cache can be (and in an embodiment is) also utilised by the neural network processing circuit when fetching neural network data from external memory. In other words, the cache system (e.g. the L2 cache or caches) is in an embodiment shared between the execution unit and the neural network processing circuit.

In an embodiment, the neural network processing circuit also has interface to the texture mapping system (and the texture cache system of the same, where one is provided).

In an embodiment, the neural network processing circuit also has at least some dedicated local storage (e.g. a buffer). For example, this may be used for storing the neural network algorithm (e.g. neural network) itself.

The feature maps, weights, biases, etc., or portions thereof, could also be stored locally to the neural network processing circuit, in dedicated respective buffers for this data. For example, a portion of the weights may be stored locally to the neural network processing circuit, or at least locally to the graphics processor (shader (processing) core).

In some embodiments, the graphics processor may also be configured to allow other storage (buffers) that is already available for the graphics processor (e.g. a tile buffer, where on is provided), and able to be re-purposed for storing data for neural network processing when required, to be used for storing neural network data. Thus, in addition to any dedicated storage (buffers) that the neural network processing circuit may have, the neural network processing circuit in an embodiment also has access to various other storage (buffers) within the graphics processor that may be re-purposed for storing data that may be required for neural network processing operations (and this may, and in an embodiment does, include any local storage of the texture mapping system, for instance).

Various other arrangements would be possible.

The technology described herein may generally find application in any suitable graphics processing system.

The technology described herein can be used for all forms of output that a graphics processor and graphics processing pipeline may be used to generate. In particular, the technology described herein may be used both for generating graphics processing outputs, such as frames for display, render to texture outputs, etc., or for general purpose (non-graphics) outputs. For example, for graphics outputs, the texture data may relate to colour, etc., data, as discussed above. For general purpose graphics processing operation, texture maps may correspondingly be used to store arbitrary data as desired (with the texturing interpolation/filtering operations then providing means for approximating arbitrary functions with data tables). Various arrangements would be possible in this regard.

In some embodiments, the graphics processor and graphics processing system comprises, and/or is in communication with, one or more memories and/or memory devices that store the data described herein, and/or store software for performing the processes described herein. The graphics processor and graphics processing system may also be in communication with a host microprocessor, and/or with a display for displaying images based on the data generated by the graphics processor and graphics processing system.

In an embodiment, the various functions of the technology described herein are carried out on a single graphics processing platform that generates and outputs the rendered fragment data that is, e.g., written to a frame buffer for a display device.

The technology described herein can be implemented in any suitable system, such as a suitably configured micro-processor based system. In an embodiment, the technology described herein is implemented in a computer and/or micro-processor based system.

The various functions of the technology described herein can be carried out in any desired and suitable manner. For example, the functions of the technology described herein can be implemented in hardware or software, as desired. Thus, for example, the various functional elements, stages, and pipelines of the technology described herein in may comprise a suitable processor or processors, controller or controllers, functional units, circuits/circuitry, processing logic, microprocessor arrangements, etc., that are operable to perform the various functions, etc., such as appropriately configured dedicated hardware elements or processing circuits/circuitry, and/or programmable hardware elements or processing circuits/circuitry that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuits/circuitry, if desired.

Thus the technology described herein extends to a graphics processor and to a graphics processing platform including the apparatus of or operated in accordance with any one or more of the embodiments of the technology described herein. Subject to any hardware necessary to carry out the specific functions discussed above, such a graphics processor can otherwise include any one or more or all of the usual functional units, etc., that graphics processors include.

It will also be appreciated by those skilled in the art that all of the described embodiments and embodiments of the technology described herein can, and in an embodiment do, include, as appropriate, any one or more or all of the optional features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processors, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a graphics processor, renderer or microprocessor system comprising a data processor causes in conjunction with said data processor said processor, renderer or system to carry out the steps of the methods of the technology described herein. Such a computer software carrier could be a physical storage medium such as a ROM chip, RAM, flash memory, CD ROM or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible medium, such as a non-transitory computer readable medium, for example, diskette, CD ROM, ROM, RAM, flash memory or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

Various embodiments will now be described by way of example only and with reference to the accompanying figures.

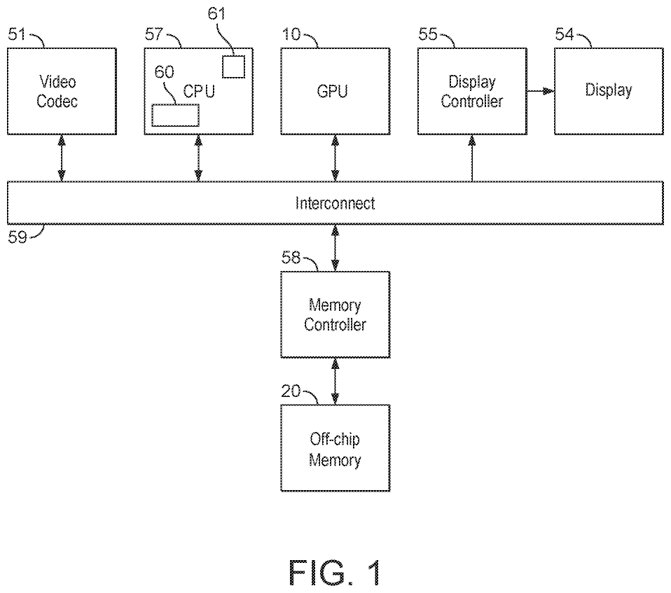

FIG. 1 shows an exemplary data processing system in which the technology described herein and the present embodiment may be implemented.

The exemplary data processing system shown in FIG. 1 comprises a host processor comprising a central processing unit (CPU) 57, a graphics processing unit (GPU) 10, a video codec 51, a display controller 55, and a memory controller 58. As shown in FIG. 1, these units communicate via an interconnect 59 and have access to an off-chip memory system (memory) 20. In this system the graphics processing unit 10, video codec 51, and/or a central processing unit 57 will generate frames (images) to be displayed, and the display controller 55 will then provide the frames to a display 54 for display.

In use of this system, an application 60, such as a game, executing on the host processor (CPU) 57, will, for example, require the display of frames on the display 54. To do this, the application 60 will submit appropriate commands and data to a driver 61 for the graphics processing unit 10 that is executing on the host processor (CPU) 57. The driver 61 will then generate appropriate commands and data to cause the graphics processing unit 10 to render appropriate frames for display and to store those frames in appropriate frame buffers, e.g. in the main memory 20. The display controller 55 will then read those frames into a buffer for the display from where they are then read out and displayed on the display panel of the display 54.

The present embodiments and the technology described herein relate in particular to the situation where the graphics processing unit 10 is using a texture when rendering a frame for output (e.g. for display). Such textures will comprise arrays of data elements (texture elements (texels)), each having an associated data value or values in the data format of the texture in question.

The textures will typically comprise images that are to be applied to graphics entities, such as primitives, to be rendered, and will normally be stored in the off-chip memory 20 from where they can then be read in by the graphics processing unit 10 when required. In particular, when using a texture to generate a render output, the graphics processing unit 10 will fetch the texture data from the memory 20 and store it in a local, texel cache of the graphics processing unit 10. The texture data will then be read from the texel cache, when needed, and used to generate the render output, e.g. frame for display.

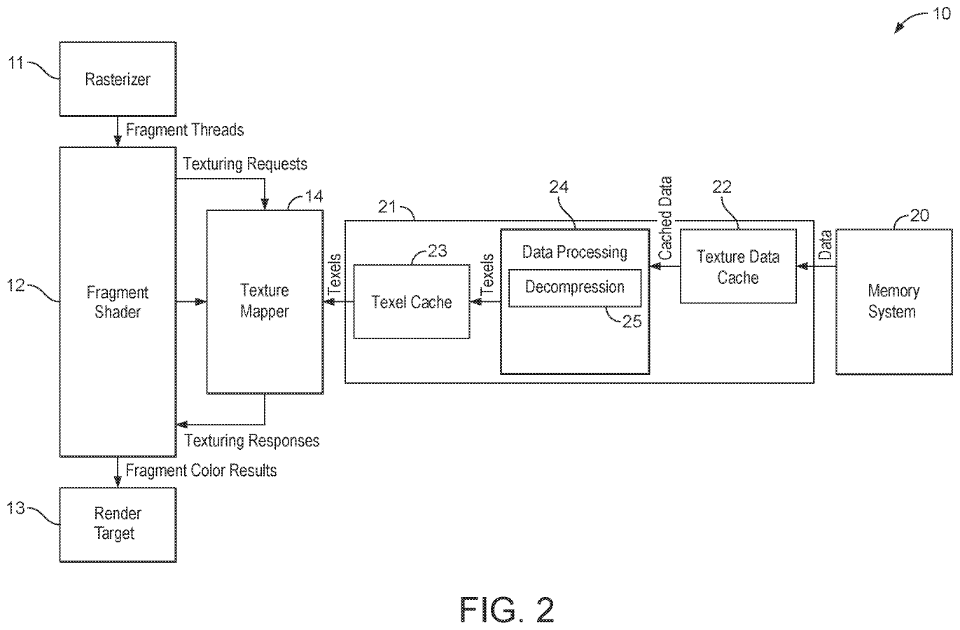

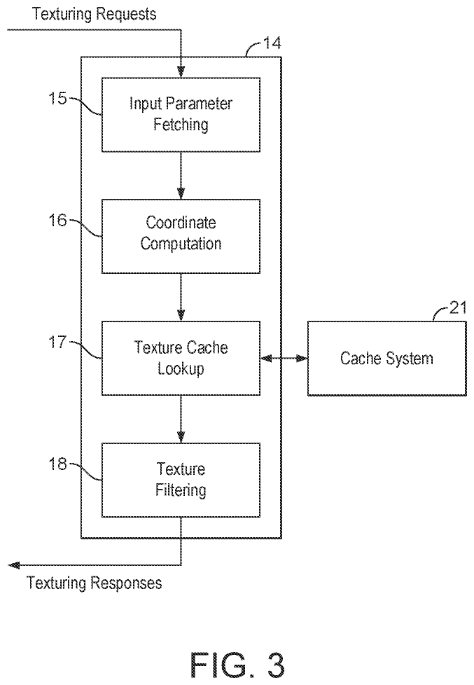

FIGS. 2 and 3 shows schematically the elements of the graphics processing unit 10 of the system shown in FIG. 1 that are particularly relevant to graphics processor texturing operations. As will be appreciated by those skilled in the art, there may be other elements of the graphics processing unit 10 that are not illustrated in FIGS. 2 and 3.

As shown in FIG. 2, the graphics processing unit 10 implements a graphics processing pipeline that includes, inter alia, a rasterizer 11, a renderer in the form of a (programmable) fragment shader 12, a buffer 13 (e.g. in memory 20) for storing the output render target (e.g. frame to be displayed), and a texture mapping unit (texture mapper) 14, and is in communication with the memory system 20.

The system memory 20 will store, inter alia, graphics textures to be used by the graphics processing unit 10. The system memory 20 may, e.g., be main memory (e.g. DDR-SDRAM (Double Data Rate Synchronous Dynamic Memory), non-volatile memory, such as Flash), e.g. a disk drive or other storage medium (e.g. a hard disk, a RAID array of hard disks or a solid state disk (SSD)) of or accessible to the host system in which the graphics processing unit 10 is located, and may be an internal storage medium of the host system, or an external or removable storage medium.

As shown in FIG. 3, the texture mapper 14 may comprise, for example, an input parameter fetching unit 15, a coordinate computation unit 16, a texel cache lookup unit 17, and a texture filtering unit 18.

As shown in FIG. 2, the texture mapper 14 interfaces with the memory system 20 via a texture cache system 21. The texture cache system 21, as shown in FIG. 2, contains a first cache 22 (a “texture data” cache) that receives data from the system memory 20, and a second cache 23 (a “texel” cache) that interfaces with the texture mapper 14 and from which the texture mapper 14 may read data of texels required for its texturing operations. The texture cache system 21 also includes a data processing unit 24 that is operable to read data from the first, texture data cache 22, process that texture data, and then provide that data to the second, texel cache 23.

The first 22 and second 23 caches of the texture cache system 21 are local memory for storing texture data, and may, e.g., comprise a RAM. They may be in the form of an SRAM memory. They each comprise a plurality of cache-lines. The second cache 23 of the cache system 21 may have a greater capacity than the first cache 22, such as having twice or four times as many cache lines as the first cache. Other arrangements would, of course, be possible.

The arrows in FIGS. 2 and 3 indicate the main ways in which data flows between the various components of the graphics processing pipeline and the memory 20. There may also be other communication routes or directions that are not indicated.

The rasterizer 11 receives as its input primitives (e.g. triangles) to be used to generate a render output, such as a frame to be displayed, and rasterizes those primitives into individual graphics fragments for processing. To do this, the rasterizer 11 rasterizes the primitives to sample points representing the render output, and generates graphics fragments representing appropriate sampling positions for rendering the primitives. The fragments generated by the rasterizer 11 are then sent onwards to the fragment shader (renderer) 12 for shading.

The fragment shader 12 executes a shader program or programs for the fragments issued by the rasterizer 11 in order to render (shade) the fragments. The fragments are processed using execution threads in the shader core, with the threads executing the shader program(s) that are to be used to process the fragments. A thread is executed for each sampling position that is to be shaded.

The shader programs may include (zero, one, or more) texturing instructions (texturing operations) that are required to be executed by the texture mapper 14. When a texturing instruction is encountered by the fragment shader 12, a texturing message is sent from the fragment shader 12 to the texture mapper 14, requesting the texture mapper 14 to follow one or more texturing instructions to perform texture processing. After the texture mapper 14 has finished its texture processing (carrying out these instructions), the final result is sent back to the fragment shader 12 in a response message for use when shading the fragment in question.

The texture mapper 14 includes suitable processing circuitry to perform texturing instructions. This processing circuitry may, e.g., be in the form of a dedicated hardware element that is configured appropriately, or it may, e.g., comprise programmable processing circuitry that has been programmed appropriately. In an embodiment, a dedicated hardware texture mapper is used.

The “shaded” fragment from the fragment shader 12 is then stored as part of the output render target in the buffer 13. For example, for a tile-based graphics processor, the buffer 13 may be a tile buffer associated with the graphics processing unit 10, with the contents of the tile buffer, once populated, then being written to the main memory 20, e.g. for subsequent display. Thus, when instructed by the fragment shader 12, the texture mapper 14 reads textures from the memory 20 (as required), performs various processing steps, and returns a colour sampled from the texture back to the fragment shader 12.

As part of this processing, the input parameter fetching unit 15 may, for example, read in the parameters of the texture to be sampled and the parameters of how to sample the texture from appropriate state information for the texture. For example, the input parameter fetching unit 15 may receive the texturing instruction message from the fragment shader 12 and this message may indicate the texture to be used (e.g. a texture field may be provided that includes a texture descriptor) and the sampling position coordinates at which to perform the texture operation.

The coordinate computation unit 16 may, for example, receive the texturing request message from the fragment shader 12 containing the coordinates to sample in the texture, together with the parameters read by the input parameter fetching unit, and determine the actual texel indices (i.e. the texels or texture data elements) in the texture to be looked up from the texel cache system 21 to perform the texture operation.

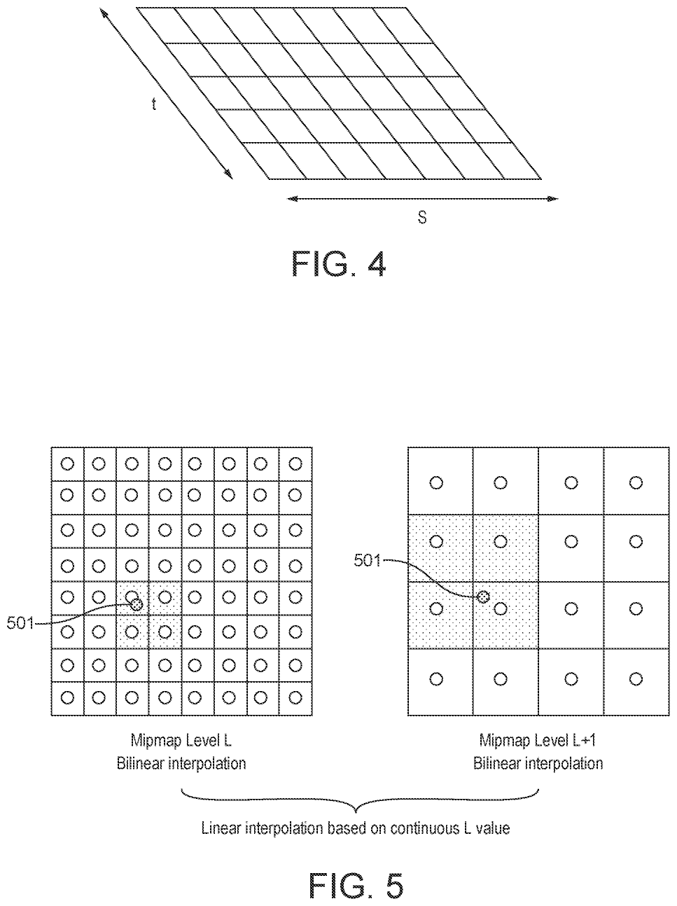

For instance, as mentioned earlier, graphics texture data is compressed in “blocks” to facilitate random access to the graphics texture. FIG. 4 shows an example of (a block of) graphics texture data, in which the texture surface is divided by into subregions that can be addressed based on respective texture surface coordinates (e.g. a pair of (s,t) co-ordinates as shown in FIG. 4). The coordinate computation unit 16 may thus map a texturing request onto the texture surface co-ordinates.

The texture cache lookup unit 17 may, for example, check whether the required texture data (i.e. the block of texture data containing texture data at the specified texture surfaces (s,t) coordinates) is stored in the second (texel) cache 23 of the texture cache system 21 and, if present, read the texture data from the second (texel) cache 23. Thus, the texture cache lookup unit 17 may check whether the required texture data elements (texels) are already stored in the second (texel) cache 23 of the texture cache system 21. If the required data is not cached locally, a request is made to fetch the required data from memory (or from a lower level of the texture cache system 21, as the case may be) into the second (texel) cache 23.

The texturing instruction is then (in an embodiment) parked into a parking buffer (not shown) to await further processing (e.g. pending the required data being fetched from the system memory and loaded into the texture cache). Once the required texture data (texture data elements) have been loaded into the second (texel) cache 23, data indicating the cache line and byte offsets where each of the texture data elements required to perform the texture operation are stored in the second (texel) cache 23 so that they can be forwarded to the texture mapper 14 as part of the texturing response.

It will be appreciated in this respect that the graphics texture data elements (texels) will typically have other than a direct correspondence with the sampling positions that are being texture mapped. Thus, further processing is typically performed to determine how the texture should be applied based on the shape, size, angle, scale, etc. of the surface that is being texture mapped. These operations are typically referred to as texture filtering operations (and will also be referred to as such in the present application). Thus, the texture cache lookup may typically lookup plural texels that are then suitably processed/filtered to determine the appearance that the associated sampling position should have.

For instance, for a typical bilinear lookup, texture data from four texels are read from a 2×2 texel region of the texture. The texture filtering unit 18 may, for example, receive the four texels of the bilinear lookup from the texel cache lookup unit, and determine interpolation weights and compute a weighted average of the texture data for the sampling position in question.

To simplify such texture filtering operations, graphics textures are often stored as a set of mipmap levels, with the different mipmap levels representing different resolution versions of the same textures. In that case, the lookup may be for textures from one or more mipmaps levels. For example, when performing anisotropic filtering, texture data from four texels may be read from a 2×2 texel region of each of two mipmap levels of the texture, with filtering then performed between the two mipmaps levels. FIG. 5 shows an example in which a lookup is being performed for a particular sampling position 501. As shown in FIG. 5, bilinear filtering is performed for the texels within respective 2×2 texel regions within two mipmap levels (level L and L+1), and linear interpolation is then performed between the two mipmap levels based on the continuous L value (overall, effectively, trilinear filtering).

Various other arrangements would be possible for filtering the texture data depending on the texture operation that is to be performed.

The filtered (interpolated) texture data for the sampling position in question is then output to (returned to) the fragment shader 12.

To facilitate storing the texture data in the memory 20 the texture data is typically (and in the present embodiment) stored in a compressed format. As mentioned above, this reduces the memory footprint of the textures in the memory 20, and also reduces the bandwidth (and energy) for fetching the texture data into the graphics processor. However, this means that the graphics processing unit 10 therefore needs to decompress texture data that is read in from the memory 20 so that the texture data is decompressed into a suitable format for use by the graphics processing operation for which the texturing request is being made.

The decompression of texture data can be performed at any suitable point along the access path to the memory 20 in which the texture data is stored. For example, as shown in FIG. 2, the data processing unit 24 of the texture cache system 21 includes one or more (hardware) decompression circuits 25 that are operable to perform decompression as data is transferred from the first, texture data cache 22 to the second, texel cache 23. Other arrangements would however be possible. For example, the texture decompression could in principle be performed at other suitable points along the memory access path.

Traditionally, each of the one or more (hardware) decompression circuits 25 supports (only) a single texture compression scheme. Thus, for each texture compression that is desired to be supported, a separate, dedicated decompression circuit 25 may be provided (with other texture compression schemes either being unsupported, or potentially being handled in software, e.g. by executing a compute shader program to perform the required decompression, which is not normally efficient). Because the decompression circuit 25 is designed and optimised for a particular texture compression scheme, this type of arrangement can be relatively inflexible. For example, a given texture compression/decompression scheme may support only a certain number of colour channels (e.g. three colour channels for data in RGB or YUV format, or four colour channels for data in RGBA format). However, modern graphics processing increasingly requires additional channels to be supported, and to address this, those channels may be stored as separate textures which then have to be obtained and decompressed separately to the colour channels.

Neural network processing therefore offers a promising approach for graphics texture compression as neural networks can be suitably configured (i.e. trained) to compress/decompress graphics textures in any desired format, such that neural network based texture compression/decompression can provide a more flexible or configurable approach for processing graphics texture data. For instance, neural network based texture compression offers possibilities for compressing multiple different graphics textures, at multiple different levels of detail, multiple different aspect ratios, etc., using appropriate neural networks. Further, as mentioned above, neural network based texture compression may be able to provide higher compression rates and image quality. As will be explained further below, the graphics processing unit 10 in the present embodiments is provided with a suitable neural network processing circuit that can be used to perform neural network processing and thus, by loading suitably selected neural networks into the graphics processing unit 10, the neural network processing circuit, can be used to execute the selected neural networks as required in order to perform graphics texture decompression into a desired format.

This therefore provides a more configurable approach as the selected neural network(s) can be loaded in as and when required to perform the desired neural network processing, thus avoiding the constraints associated with using fixed decompression circuits 25, e.g. as may be done in more traditional graphics processor arrangements. Thus, the neural network processing circuit may be configured and optimised for neural network execution, but is free to execute any suitable and desired neural networks, which can provide much greater configurability or support for performing different types of (neural network based texture) compression/decompression schemes. That is, rather than having specific hardware circuits to support specific compression schemes (with multiple different hardware circuits thus being required to support multiple different compression schemes, with associated silicon area costs), the approach according to the present embodiments, where an appropriate neural network processing circuit is available to accelerate neural network processing, means that the same neural network processing circuit (hardware) can be used to execute different neural networks, e.g. by changing the weights/neural network model using software.

In this respect, it will be appreciated that neural networks can be (and already are) used for various image processing operations, including in a graphics processing context for image enhancement (“de-noising”), segmentation, “anti-aliasing”, supersampling, etc., in which case a suitable input image may be processed using a neural network to provide a desired output image, and also for image compression. Neural networks are therefore also well-suited for graphics texture compression.

For instance, a neural network may operate upon suitable input data (e.g. such as an image) to ultimately provide a desired output. In the context of graphics texture compression, a neural network may thus be used to process input data, e.g. in the form of a graphics texture that is to be compressed, into a desired output, in this case a compressed format version of that graphics texture. Correspondingly, another (e.g. ‘reverse’) neural network may be used to process (i.e. decompress) such a compressed format version of a block of graphics texture data back into graphics texture data in a suitable format for use by a graphics processor texturing operation.

These compression/decompression processes may thus generally be considered as examples of neural network “inferencing” processes.

In general, a neural network will typically process the input data (e.g. texture data to be compressed/decompressed) according to a network of operators, each operator performing a particular operation. The operations will generally be performed sequentially to produce desired output data (e.g. based on the input texture data). Each operation may be referred to as a “layer” of neural network processing.

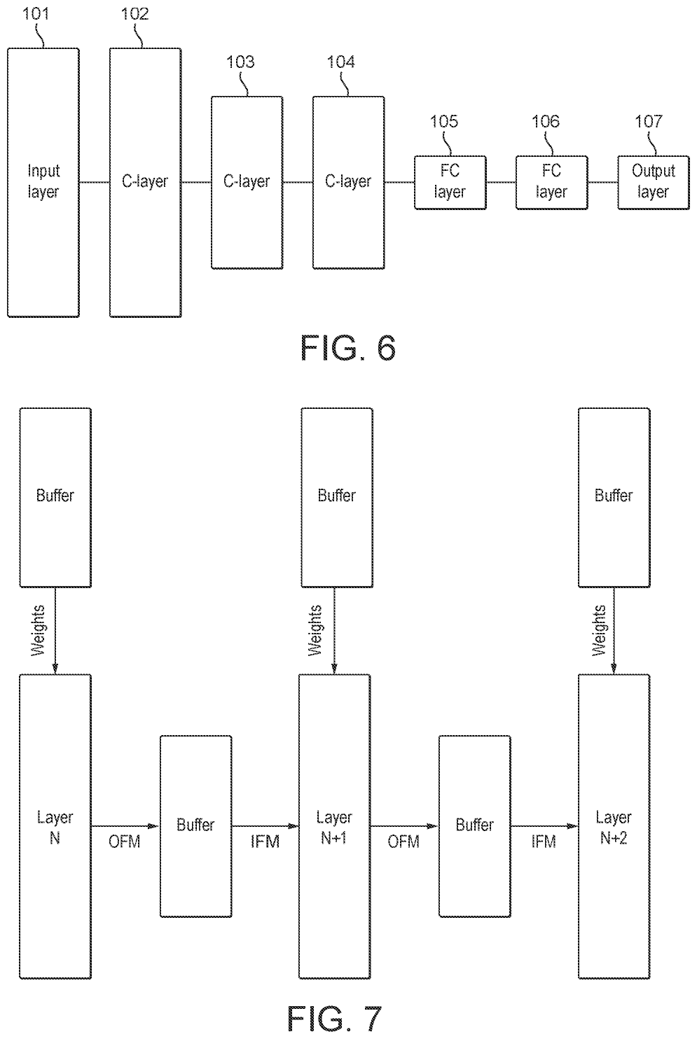

Hence, neural network processing may comprise a sequence of “layers” of processing, such that the output from each layer is used as an input to a next layer of processing. FIG. 6 shows an exemplary sequence of layers of neural network processing from an initial input layer 101 to a final output layer 107, between which are layers comprising various convolutional layers (C-layers) 102, 103, 104, and fully-connected layers (FC layers) 105, 106. Such a neural network may also comprise other additional layer types (which are not shown in FIG. 6), such as a deconvolution layer, as appropriate.

The input layer 101 may be configured to receive input data (e.g. an image to be compressed/decompressed), and to provide that input data in a suitable form (e.g. as an array of data elements, otherwise known as a “feature map”) for use by subsequent neural network layers.

The feature map will generally comprise a three-dimensional array of data elements, each data element having data associated therewith. The feature map may have a width (W), a height (H) and a depth (C), wherein the width (W) and height (H) may be defined as the number of data elements in the width and height direction respectively, and the depth (C) may correspond to a number of data channels. For example, in the case of input data comprising an image (e.g. a graphics texture), the width and height of the array provided by the input layer may correspond to a number of data positions (e.g. pixels/texels) along the width and height direction of the image respectively, whilst the channels may comprise the RGB(A) colour channels of the image. To allow for random access, the image may be compressed and decompressed in multiple, smaller, blocks/regions.

After the input layer, there may be one or more other layers of neural network processing (e.g. including convolutional layers, fully-connected layers, pooling layers, deconvolution layers, or any other layers of neural network processing that may be present).

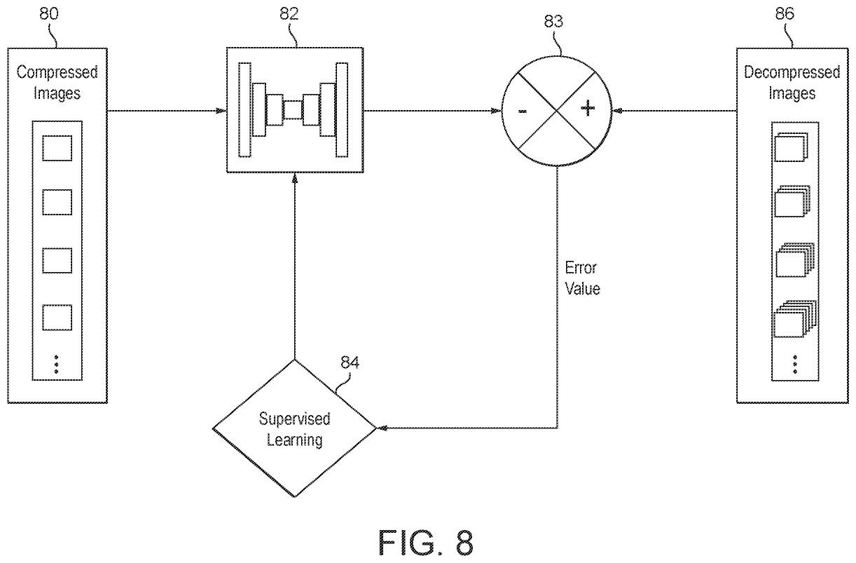

Generally, a layer of neural network processing will process an input feature map (IFM) in order to generate a corresponding output feature map (OFM) (e.g. in the case of a convolutional layer, deconvolution layer, or pooling layer), or output value (e.g. a probability in the case of a fully-connected layer). The output generated by a layer of neural network processing will be used as the input for a next layer of neural network processing in the sequence, and so on. This is illustrated in FIG. 7.

The operation performed by each layer of neural network processing may comprise any suitable operation which manipulates an input (feature map) to provide an output (feature map). The operation may require process parameters (e.g. such as weights for a filter or “kernel”) which may be specific to a particular layer of neural network processing. Hence, as shown in FIG. 7, suitable process parameters (e.g. weights and biases) may be read from working memory (e.g. a buffer) in order to perform each layer of neural network processing.

With reference to FIG. 6, the final layer of neural network processing in the sequence may comprise an output layer 107. The output layer may process an input feature map to generate useful output data (e.g. an output compressed texture/decompressed texture block in the case of graphics texture data compression/decompression schemes).

Whilst FIG. 6 shows an example of a particular convolutional neural network, it will be appreciated that a neural network may have various other layer types, and/or network architectures (e.g. a recurrent neural network architecture).

An aspect of the technology described herein therefore relates to the use of neural networks, such as those described above, for graphics texture compression, and correspondingly for graphics texture decompression. For example, as alluded to above, a neural network can be suitably trained to compress graphics texture data (and to do so in such a manner that permits random access to the graphics texture data), and another (reverse) neural network can correspondingly be trained to decompress graphics texture data that has been compressed in this way. This training can be done in any suitably and desired manner for training a neural network. For example, in embodiments, this is done by a process of “supervised learning”, as shown in FIG. 8.

FIG. 8 thus shows schematically an example of a training process in which supervised learning is performed (at step 84) in order to train a neural network 82 to perform graphics texture compression/decompression. In particular, in this example, the neural network 82 is being trained to perform graphics texture decompression. In this case, a set of compressed image regions (i.e. “blocks” of compressed texture data) 80 is provided as input to the neural network 82. The neural network 82 then learns to decompress these compressed images/regions 80 by comparing its output with a corresponding set of ground truth decompressed images/regions 86 (at step 83) and using the resulting error value to guide the supervised learning (step 84). In this example, the neural network 82 learns to decompress each channel individually. Also, each channel in the compressed texture has the same width and height.

However, the training can generally be done in various ways as desired depending on the neural network processing that the neural network(s) is desired to do, as will be discussed further below.

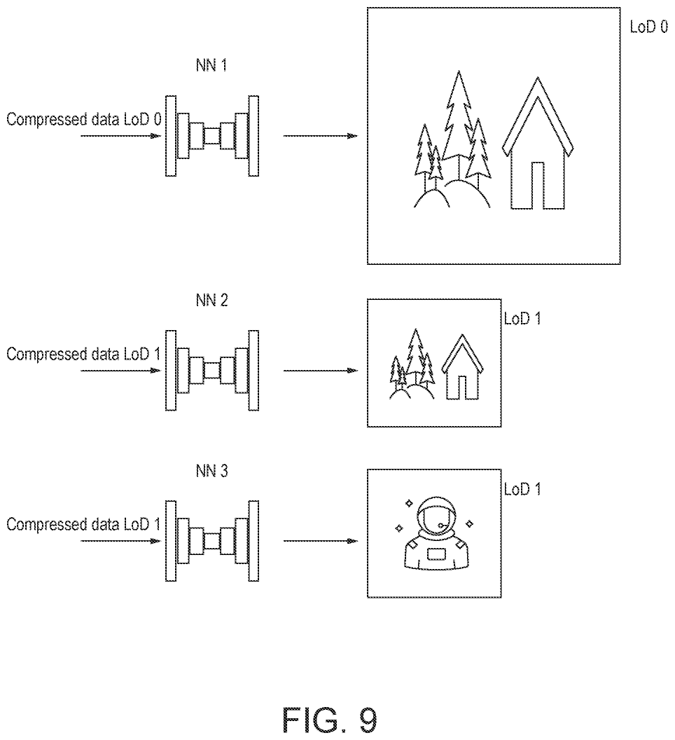

For example, in some cases, as illustrated in FIG. 9, a plurality of different neural networks may be trained with each neural network being configured and trained to process a single texture at a single level of detail. In this case, each neural network may be trained separately.

Thus, as shown in FIG. 9, a first neural network (NN1) may be provided that is configured to output a first texture at a first level of detail (LoD0). Correspondingly a second neural network (NN2) is provided that is configured to output the same first texture but at a second level of detail (LoD1). FIG. 9 also shows a third neural network (NN3) that is configured to output a second, different texture at the second level of detail (LoD1). In this way, many different neural networks may be trained and the appropriate neural network can then be selected, as will be discussed further below, depending on the texture that is required, the desired level of detail, etc., and loaded in to the graphics processor accordingly to perform the neural network texture decompression.

However, where many neural networks are used, the respective neural network may have to be fetched into the graphics processor to perform any required neural network processing before that processing can be performed. In this regard, the present Applicants recognise that a particular benefit of neural network based texture compression/decompression schemes is that by suitable configuration and training of a neural network (or set of neural networks) it is possible to extend or generalise the functionality of the neural network, thus potentially reducing the number of neural networks that may be required (and hence potentially reduce memory bandwidth).

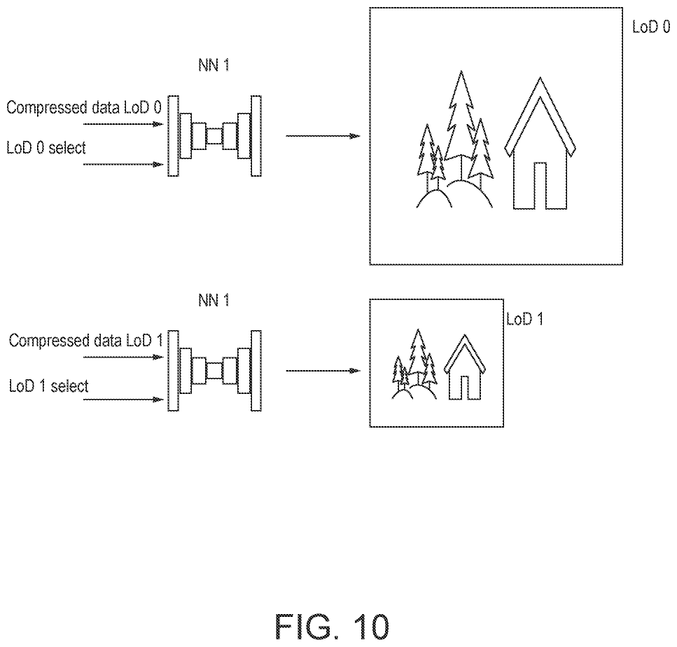

For example, in FIG. 9, as described above, a separate neural network is used for each level of detail. FIG. 10 shows another example where a single neural network (NN1) is able to output different levels of detail. For instance, this can be done by extending the training of the neural network to compress multiple levels of graphics textures (i.e. multiple mipmap levels) together. Then, when compressed data is passed to the neural network for decompression, a request may be issued to the neural network to provide the decompressed data at a desired level of detail, and the neural network can then process (i.e. decompress) the graphics texture data accordingly to provide the decompressed texture at the requested level of detail. This can then potentially avoid the need for multiple mipmap level fetches as multiple mipmap levels can potentially be computed and provided in one go.

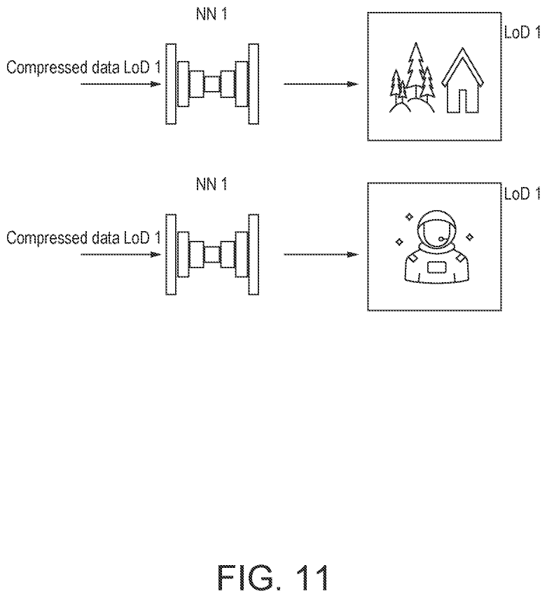

FIG. 11 shows another example where a single neural network is used for multiple different texture types (which may, e.g., be generally similar texture types, such as different wood grains, etc.). In this case, a group of plural different types of textures may be compressed using a single, same neural network (such that a single, same neural network may correspondingly be used to decompress any of the textures within the selected group of textures). In this case, the application programmer may select a suitable groups of textures that are to be compressed/decompressed using the same neural networks, or this could be worked out by the or another neural network when performing the compression.

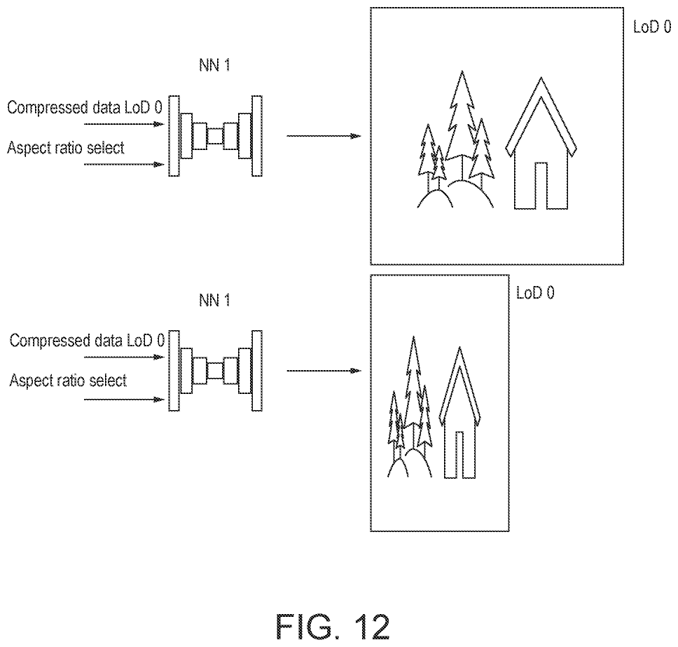

In the examples above it is generally assumed that all textures have the same height and width. However, it would also be possible to train a neural network to provide different aspect ratios. An example of this is shown in FIG. 12.

Another advantage of using neural network processing is that neural networks can be used to perform additional processing beyond the decompression.

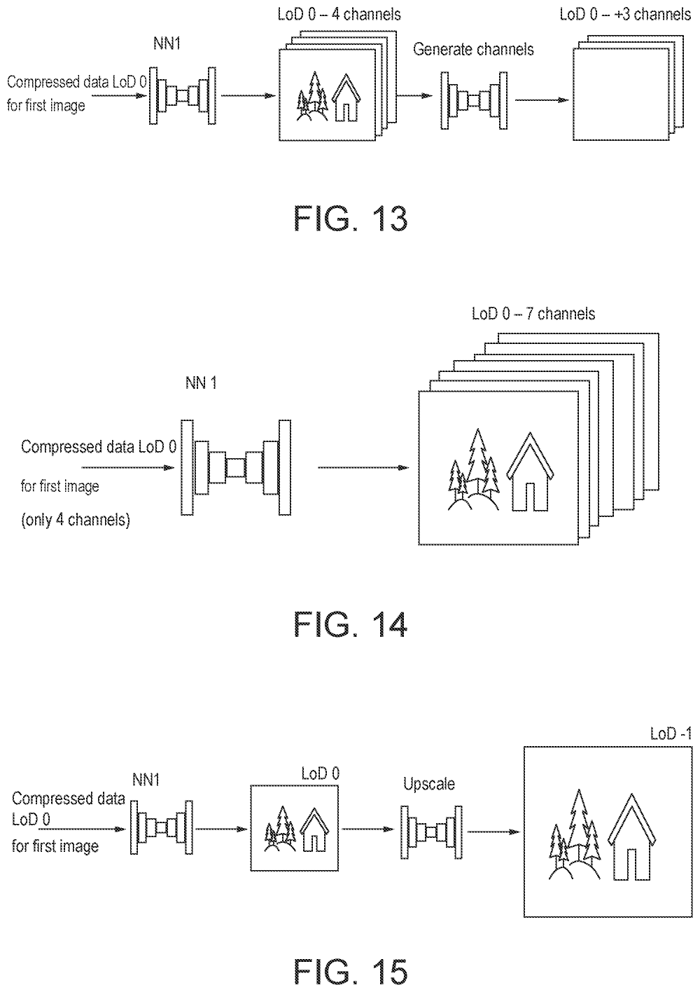

For instance, it is often the case that a graphics processing operation may require multiple channels of data whereas a stored graphics texture may contain fewer channels (e.g. the stored graphics texture data may contain RGBA values but not luminance, light/shadow, etc., values). FIG. 13 shows an example where further neural network processing is performed to generate such additional channels. In FIG. 13 this is done using a separate neural network, after the decompression. However, this could also be done in a single step, using a single neural network that is configured to generate such additional channels as part of the decompression, e.g. as shown in FIG. 14.

Another example of this would be for upscaling a texture. FIG. 15 thus shows an example where a separate neural network is used to upscale a texture to a larger size and/or higher quality. For instance, neural networks are already used for image upscaling in other contexts and can also suitably be used for upscaling graphics textures. Although not shown in FIG. 15, the neural network used to perform neural texture decompression may also be trained and used to perform upscaling of the texture to a larger size and/or higher quality.

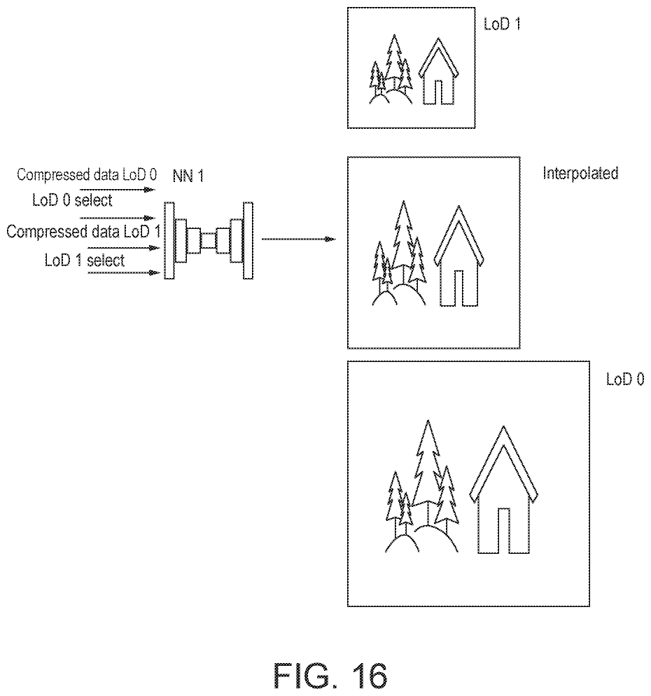

A further example of where neural network processing may be particularly interesting in the case of graphics texturing operations is illustrated in FIG. 16 where the neural network is trained to provide an interpolated (filtered) texture value. For example, texture filtering may be performed, as discussed above in relation to FIG. 3, to determine how a given texture should be applied based on the shape, size, angle, etc., of the surface to which the texture is being applied. Thus, the coordinate computation 16 and texture cache lookup 17 in FIG. 3 may determine where on the texture each sampling position falls. However, a sampling position does not usually correspond directly to one texel, such that some form of filtering (interpolation) is normally applied to determine the appropriate appearance of the texture at the sampling position in question based on the texels that are represented by the sampling position. Typically, as shown in FIG. 3, this is done by the dedicated texturing filtering stage 18 of the texture mapping unit (texture mapper) 14. However, in embodiments, the neural network processing may also be configured to perform the desired texture filtering operations (i.e. that would otherwise be done by the texturing filtering stage 18 in FIG. 3), such that the neural network processing effectively returns filtered texture data, thus potentially avoiding having to do this separately/again in the texture mapping unit.

Performing at least some texture filtering operations by neural network processing may be particularly advantageous in combination with the approaches described above in relation to FIG. 10 wherein multiple mipmap levels can be requested and in relation to FIG. 12 where different aspect ratios can be requested. For instance, these operations together can help support trilinear and/or anisotropic filtering implementations. Performing texturing filtering operations at least in part by neural network processing can therefore simplify the texture filtering hardware needed to support different types of filtering (and avoid having to do this by general purpose compute shader execution, which may be less efficient).

It will be appreciated from the above examples that neural network processing may thus provide various benefits in the context of graphics texture compression/decompression such that it is desirable to more efficiently support such neural network based texture compression/decompression on graphics processors.

This support could be achieved by including a suitable (dedicated) neural network texture decompression circuit, e.g. as another decompression circuit 25 within the data processing unit 24 of the texel cache system 21, and providing suitable interfaces for that network texture decompression circuit to load in any selected neural networks, as required.

In this respect, the present Applicants however recognise that there are various other examples of (non-graphics texture related) neural network processing that may be performed when performing graphics processing, and that it may already be advantageous for the graphics processor to have a separate on-chip neural engine to support this, which (existing) neural engine can therefore advantageously also be used to support neural network based texture compression/decompression schemes.

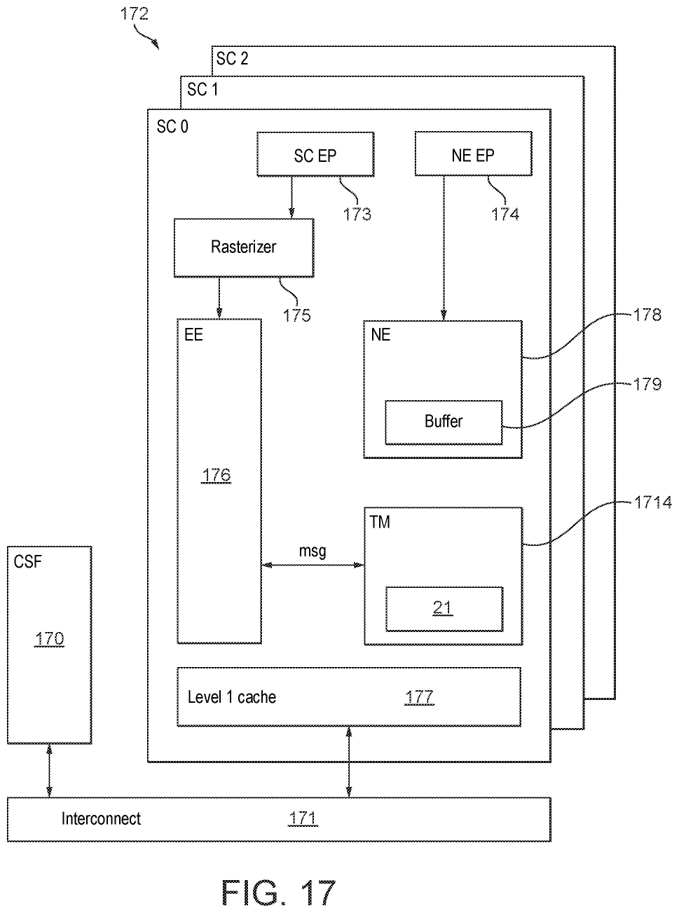

An example of a graphics processor including such a neural engine is shown in FIG. 17. FIG. 17 shows schematically certain relevant elements and components of a graphics processor.

As shown in FIG. 17, the graphics processor includes one or more shader (processing) cores 172 that are provided along the same interconnect 171 (which interconnect 171 may, for example, provide communication to a shared (L2) cache (not shown) which is operable to communication with the off-chip memory system). A command processing circuit (in the form of a command stream frontend, “CSF”) 170 is also provided that is operable to communicate over the interconnect 171 with the respective shader (processing) cores 172 to schedule processing jobs.

FIG. 17 shows schematically the relevant configuration of one shader core (SC0), but as will be appreciated by those skilled in the art, any further shader cores 172 of the graphics processor will be configured in a corresponding manner.

As will be appreciated by those skilled in the art there may be other elements of the graphics processor that are not illustrated in FIG. 17. It should also be noted here that FIG. 17 is only schematic, and that, for example, in practice the shown functional units may share significant hardware circuits, even though they are shown schematically as separate units in FIG. 17. It will also be appreciated that each of the elements and units, etc., of the graphics processor as shown in FIG. 17 may, unless otherwise indicated, be implemented as desired and will accordingly comprise, e.g., appropriate circuits (processing logic), etc., for performing the necessary operation and functions.

As shown in FIG. 17, the (and each) graphics processor shader (processing) core (SC0) comprises a programmable processing unit (circuit) in the form of execution engine (EE) 176 that perform processing operations by running small programs (often referred to as “shader” programs) for each “item” in an output to be generated such as a render target, e.g. frame. (An “item” in this regard may be, e.g. a vertex, one or more sampling positions, etc.) The shader cores will process each “item” by means of one or more execution threads which will execute the instructions of the shader program(s) in question for the “item” in question. Typically, there will be multiple execution threads each executing at the same time (in parallel).

The shader (processing) core (SC0) may also include, for example, an instruction cache (not shown) that stores instructions to be executed by the execution engine 176 to perform graphics processing operations.

The shader (processing) core (SC0) also includes an appropriate local (L1) cache 177, that is operable, e.g., to load into an appropriate cache, data, etc., to be processed by the execution engine 176, and to write data back to the memory system (via any shared cache system when present) (for data loads and stores for programs executed in the execution engine 176).

As shown in FIG. 17, the shader (processing) core (SC0) also includes a texture mapper unit in the form of texture mapping apparatus 1714, which is in communication with the execution engine 176, and which is operable to perform texturing operations. The texture mapping apparatus 1714 includes suitable processing circuitry to follow texturing instructions. In the present embodiments, this processing circuitry is in the form of one or more dedicated hardware elements that are configured appropriately, e.g. as discussed above. The texture mapping apparatus 1714 has a local buffer, which may correspond to texture cache system 21 discussed above, and is in an embodiment also operable to fetch data from the memory system (although this is not shown in FIG. 17).

In order to perform graphics processing operations, the execution engine 176 will execute graphics shader programs (sequences of instructions) for respective execution threads (e.g. corresponding to respective sampling positions of a frame to be rendered). Accordingly, as shown in FIG. 17, the shader core (SC0) further comprises a fragment thread creator (generator) in the form of shader core endpoint 173 that operable to generate execution threads for execution by the execution engine 176 as desired.

The command stream frontend 170 may thus issue fragment processing jobs to the shader core endpoint 173 of a respective shader core accordingly. The command stream frontend 170 is also generally able to schedule other desired processing work for the graphics processor, including both normal graphics processing work, as well as compute and neural network processing work.

To facilitate the performance of neural network processing work using the graphics processor, the shader cores 172 of the graphics processor are in the embodiment shown in FIG. 17 each provided with a respective neural network processing circuit (neural engine, “NE”) 178. In FIG. 17, the neural engine 178 is provided with its own separate neural endpoint 174 to which neural network processing jobs can be submitted by the command stream frontend 170. The neural engine 178 is also provided with a respective neural buffer 179 for storing the required data for the neural network processing (which may include the data defining the neural network itself, including the weights, biases, etc., as well as the input/output feature maps for the neural network processing).

Thus, in FIG. 17, neural network processing work may be triggered by the command stream frontend 170 issuing a suitable processing task to a respective graphics processor shader core, which task is then scheduled to the neural engine 178 by the separate neural endpoint 174.

Thus, the graphics processor in FIG. 17 includes a dedicated “on chip” neural network processing circuit that is associated with, and local to, the graphics processor itself. This then means that the neural network processing circuit is operable, e.g., to utilise some of the graphics processor's existing resource (e.g. such that at least some functional units and resource (e.g. the overall job control, and any shared storage) of the graphics processor can effectively be shared between the neural network processing circuit and execution unit, for instance), whilst still allowing an improved (more optimised) performance compared to, e.g., the graphics processor only being able to perform neural network processing with general purpose execution in the execution unit (or using an entirely separate unit that is independent of the graphics processor, such as an entirely separate neural processing unit, “NPU”, that is operable to perform neural network processing on demand by the host processor (CPU) 57 and that is provided along the same interconnect (bus) 59 in parallel with the graphics processing unit 10).

The arrangement shown in FIG. 17 can thus work well to perform some neural network processing locally to the graphics processor. This can be particularly useful for neural network processing relating to other graphics processing operations such as when performing so-called “super sampling” and/or other “anti-aliasing” techniques using deep learning processing. Another example might be for de-noising applications when performing a ray tracing process.

The arrangement shown in FIG. 17 can also be used in the same way to perform neural network based texture decompression. However, the arrangement shown in FIG. 17 is not configured for neural texturing operations in particular, and the messaging protocol for texturing operations may therefore be relatively complicated as any neural texturing instructions may have to go back through the neural engine endpoint, potentially after having first checked the texture cache system 21, and this may introduce significant latency.

For instance, as an example, for fragment processing jobs, the command stream frontend 170 may send a processing job to the shader core endpoint 173, which then sends the primitives that are to be processed to the rasterizer 175. The rasterizer 175 then sends tasks to the execution engine 176 to execute the desired shader program. The execution engine 176 then executes instructions from the shader program. In response to executing a traditional (i.e. non neural) texturing instruction, the execution engine 176 then messages the texture mapping unit (texture mapper) 1714, e.g. in the normal manner, to request the required graphics texture data.

Thus, in the same manner described above, the texture mapping unit (texture mapper) 1714 checks its buffer (e.g. the texture cache system 21) to determine whether the requested texture data (at the desired (s,t) co-ordinates) has already been decompressed and is already locally available. If so, the requested texture data is returned to the texture mapping unit (texture mapper) 1714, filtered (interpolated) as required, and the filtered (interpolated) value is then returned to the execution engine 176.

On the other hand, for any neural texturing instructions included in the shader program, the execution engine 176 in FIG. 17 cannot directly communicate with the neural engine 178, and so any texturing requests must be sent to the neural engine 178 via the overall job control, i.e. by having the command stream frontend 170 send an appropriate job to the neural endpoint 174.

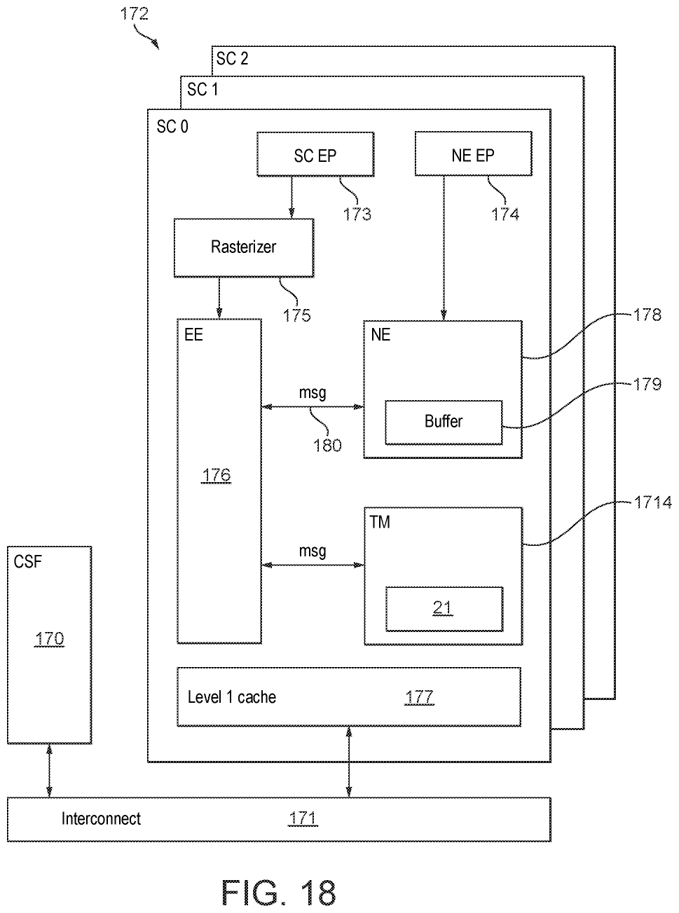

FIG. 18 thus shows another arrangement in which the execution engine can directly message the neural engine and this can provide various improvements in this regard. Thus, as shown in FIG. 18, an additional messaging interface 180 is provided between the execution engine 176 and the neural engine 178.

Therefore, in this arrangement, in response to the programmable execution engine executing a neural texturing instruction, the programmable execution engine may be able to directly message the neural engine 178 to perform the desired neural network processing. In this case, the neural engine 178 can be triggered to perform neural network processing directly by the execution engine 176, rather than only via the separate neural endpoint 174. Thus, any neural texturing operations can be performed under the control of the execution engine 176, with the shader program including the neural texturing instructions being issued to the fragment shader endpoint 173, as normal, and the execution engine 176 messaging the neural engine 178 appropriately in response to executing a suitable neural texturing instruction.

Accordingly, in FIG. 18, the neural engine 178 is operable to communicate with the execution engine 176 internally to the graphics processor when performing neural texturing operations (in addition to having its own separate neural endpoint 174 that may be used for scheduling other, non-texture related processing).

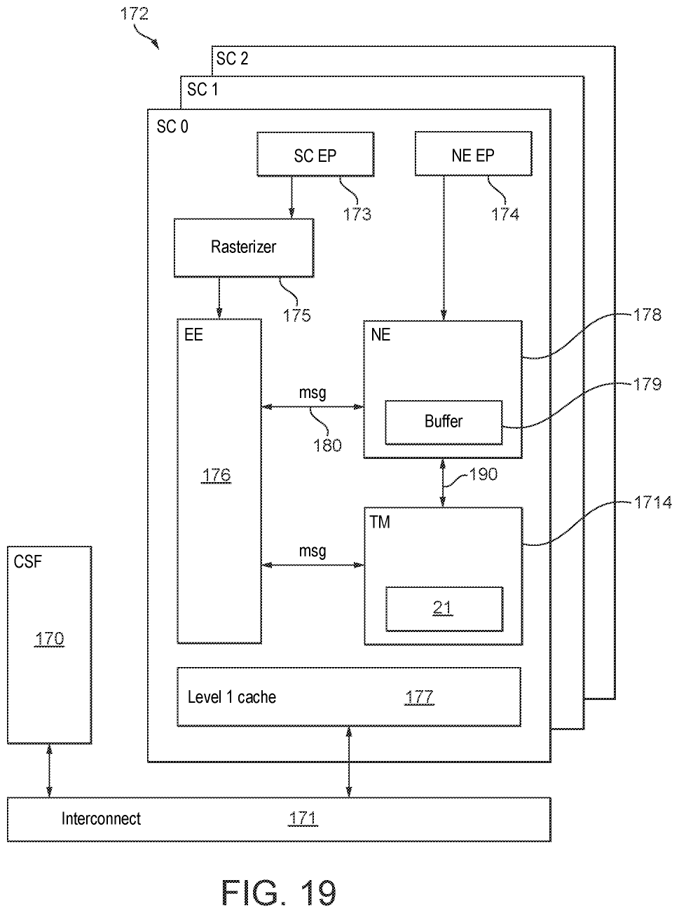

FIG. 19 shows a graphics processor shader core arrangement according to an embodiment in which a further additional messaging interface 190 is provided between the texture mapping unit (texture mapper) 1714 and the neural engine 178. As will be explained further below, this can then provide a highly efficient implementation of neural network based texturing.

For example, in this arrangement, in response to the execution engine 176 executing a neural texturing instruction, the execution engine 176 may initially message the texture mapping unit (texture mapper) 1714, with the texture mapping unit (texture mapper) 1714 then checking whether the required texture data is available locally (in the texture cache system 21), e.g. as per a normal texturing request. However, in the case that the required texture data is not available locally (in the texture cache system 21), the texture mapping unit (texture mapper) 1714 can then message the neural engine 178 to fetch and decode the block of texture data. After the neural engine 178 has decompressed the required block of texture data, the decompressed texel values can be sent back to the texture mapping unit (texture mapper) 1714 to perform any required further processing (texture filtering, etc.), with the texture mapping unit (texture mapper) 1714 then returning the required (filtered) values to the execution unit 176.

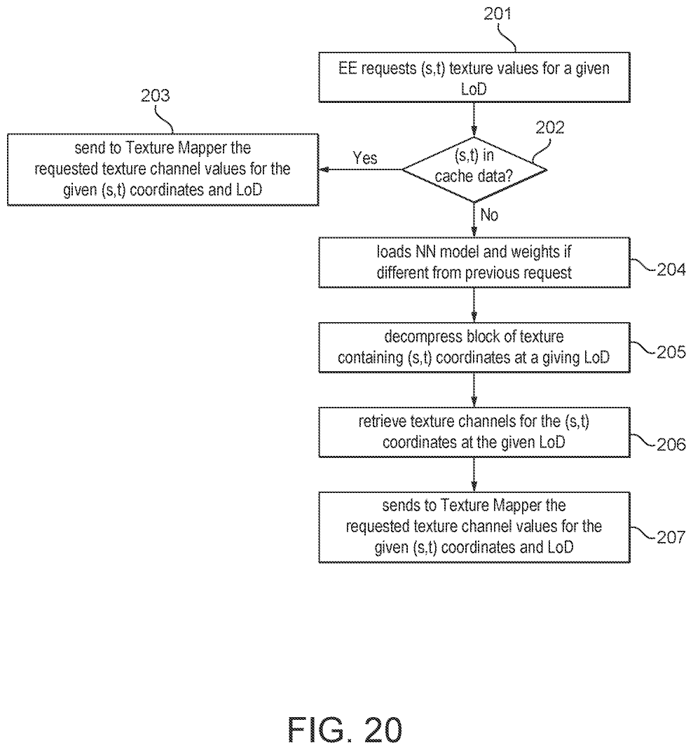

An example of this operation is shown in FIG. 20. FIG. 20 thus shows an example of a texturing operation according to an embodiment wherein in response to the execution engine (i.e. fragment shader) requesting texture coordinate (s,t) values for a given level of detail (step 201), the execution engine 176 directly messages the neural engine 178. If the requested texture values (i.e. at the specified (s,t) coordinates) are already stored locally to the neural engine 178 (step 202—yes), the neural engine 178 then sends the requested texture channel values for the specified texture (s,t) co-ordinates and level of detail to the texture mapping unit (texture mapper) 1714 (step 203), and the texture mapping unit (texture mapper) 1714 then processes the values accordingly, and returns a suitable texturing response to the execution engine 176.

On the other hand, if the requested texture (s,t) values are not already stored locally to the neural engine 178 (step 202—no), the neural engine 178 should then load in the appropriate neural network model weights and biases (if the correct neural network is not already loaded in from a previous request) (step 204), and then decompress the block of texture containing the requested texture (s,t) values at the desired level of detail (step 205). The neural engine 178 then retrieves the texture channel values for the specified texture (s,t) co-ordinates and level of detail from the decompressed block (step 206) and sends the requested texture channel values for the specified texture (s,t) co-ordinates and level of detail to the texture mapping unit (texture mapper) 1714 for further processing (step 207, similarly to step 203 above).

Alternatively, and in other examples, in response to the execution engine 176 executing a neural texturing instruction, the execution engine 176 may directly message the neural engine 178. The neural engine 178 can then determine whether the requested texture data (at the requested (s,t) coordinates) is available within its buffer 179, and if not the required block of texture data is fetched and decompressed from memory by the neural engine 178. In FIG. 18, after the block had been decompressed, the neural engine 178 would then have to message the execution engine 176 to continue the processing, e.g. by sending a dedicated neural texture message response, with the execution engine 176 potentially having to then message the texture mapping unit (texture mapper) 1714 to perform any required further processing (texture filtering, etc.). In contrast, in FIG. 19, after the neural engine 178 has decompressed the required block of texture data, the decompressed texel values can be sent directly to the texture mapping unit (texture mapper) 1714 to perform any required further processing (texture filtering, etc.), with the texture mapping unit (texture mapper) 1714 then returning the required (filtered) values to the execution unit 176.

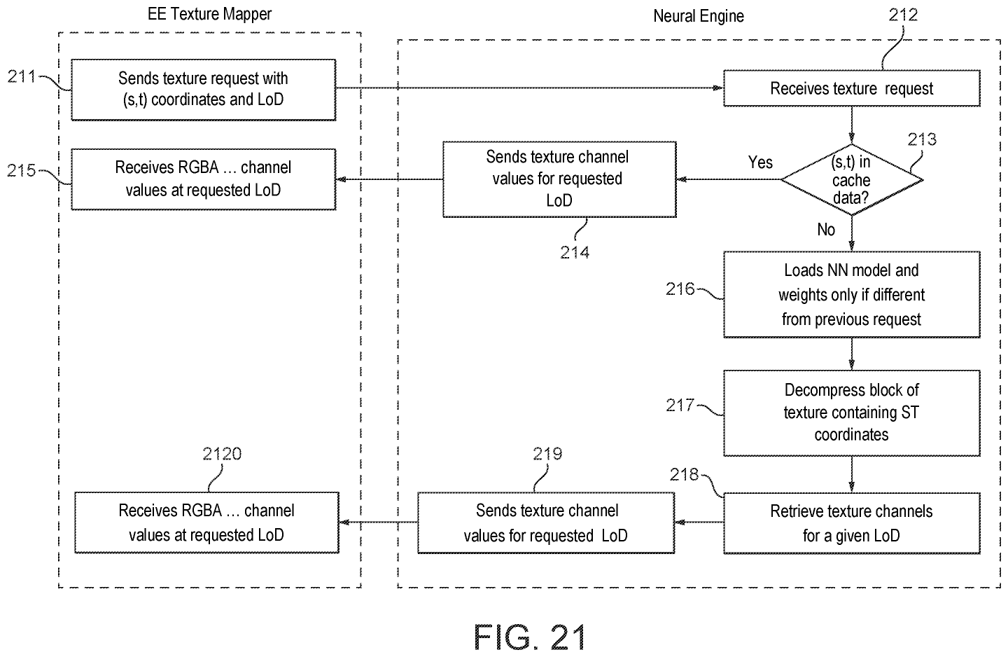

An example of this operation is shown in FIG. 21. Thus, in FIG. 20, the texturing request is initially handled by the neural engine 178 with the neural engine 178 then processing the request and returning the requested data via the texture mapping unit (texture mapper) 1714, whereas FIG. 21 shows another example in which the texturing request is initially handled by the texture mapping unit (texture mapper) 1714.

Thus, in FIG. 21, neural texturing requests are initially sent from the execution engine 176 to the texture mapping unit (texture mapper) 1714 (e.g. in the same way that non-neural texturing requests would be) (this step is not shown in FIG. 21). In this case, in response to the texture mapping unit (texture mapper) 1714 receiving a texturing request for texture data requiring neural network decompression, the texture mapping unit (texture mapper) 1714 may then send the texture request including the requested (s,t) coordinates and level of detail to the neural engine 178 (step 211). The neural engine 178 on receiving such texture request (step 212) then checks whether the requested texture data is already stored locally to the neural engine 178, and if so (step 213—yes), is operable to return the texture channel values for the requested level of detail to the texture mapping unit (texture mapper) 1714 immediately (step 214). The texture mapping unit (texture mapper) 1714 on receiving the requested data (step 215) can then perform any desired further processing (e.g. filtering) before returning the required graphics texture data values to the execution engine 176.

On the other hand, if the requested texture data is not already stored locally to the neural engine 178 (step 213—no), the neural engine 178 then loads in the appropriate neural network model weights and biases (if the correct neural network is not already loaded in from a previous request) (step 216), decompresses the block of texture containing the requested (s,t) coordinates (step 217) and retrieves the texture channels for a given level of detail (step 218). The neural engine 178 can then provide the texture channel values for the requested level of detail to the texture mapping unit (texture mapper) 1714 (step 219) for further processing thereby (step 2120, similarly to step 215 above).

Various other arrangements would be possible in this regard depending on the configuration of the graphics processor. For example, referring to FIG. 21, rather than the initial checking of whether the required texture data is already stored locally being performed by the neural engine 178 (at step 213), an initial check could be performed by the texture mapping unit (texture mapper) 1714, with the neural engine 178 operation then only being triggered if the data is not already available in the texture cache system 21. In that case, the neural engine 178 should return the full decompressed block to the texture mapping unit (texture mapper) 1714 for storing in the texture cache system 21.

Likewise, referring particularly to FIG. 20, in arrangements such as that shown in FIG. 18 where the neural engine 178 cannot directly exchange messages with the texture mapping unit (texture mapper) 1714, in that case the neural engine 178 may return the texel values to the execution engine 176 for further processing, with the execution engine 176 then triggering the texture mapping unit (texture mapper) 1714 operation, as required.

Thus, FIG. 20 and FIG. 21 illustrate various examples of how neural texturing operations may be supported by a graphics processor, but various other examples would be possible.

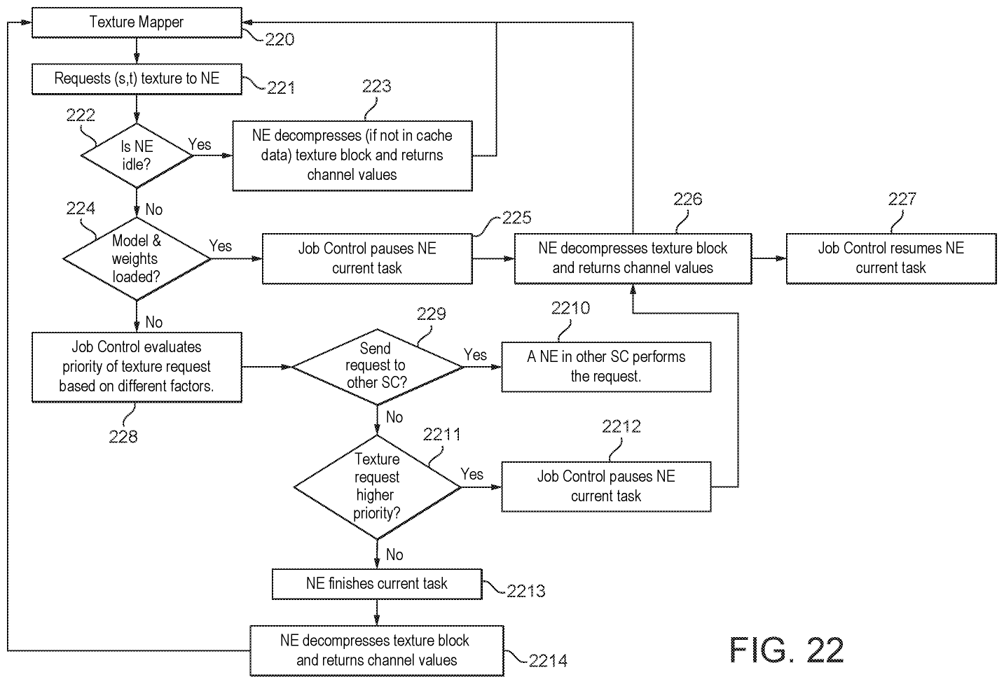

In that respect, it will be appreciated that the neural engine 178 may be, and typically is, also available to perform other, non-texture related neural network processing (and this is scheduled by the neural engine endpoint 174, as desired). Thus, a mechanism for arbitrating between different types of neural network processing is in an embodiment provided. An example of a suitable arbitration scheme is shown schematically in FIG. 22. In particular, FIG. 22 shows an arbitration scheme in the context of the operation described above in relation to FIG. 21 in which the texture mapping unit (texture mapper) 1714 is operable to message the neural engine 178 to request texture data (step 221 in FIG. 22). However, it will be appreciated that similar arbitration may be performed in other examples.

As shown in FIG. 22, when the texture mapping unit (texture mapper) 1714 requests texture data from the neural engine 178 (step 221), so long as the neural engine 178 is idle (step 222—yes), the neural engine 178 can then process the neural texturing request immediately (step 223—corresponding to the operations shown in FIG. 21, above). On the other hand, if the neural engine 178 is not currently idle (step 222—no), i.e. because it is busy with some other non-texture related neural network processing, it is then decided based on various metrics whether the neural texturing operations should be performed immediately, or whether the neural engine 178 should be allowed to continue its other non-texture related neural network processing.

For example, in the scheme depicted in FIG. 22, it is first checked whether the required neural network model and weights for performing the neural texturing operation are already loaded. If so (step 224—yes), the neural engine 178 job control (i.e. neural endpoint 174) is operable to pause the current (other) neural network processing task (step 225) to allow the neural texturing operations to be performed (step 226). Once the neural texturing operations have been performed, the job control can then resume processing the neural network processing task that was paused (step 227).

Assuming the required neural network model and weights for performing the neural texturing operation are not already loaded (step 224—no), the neural engine 178 job control (i.e. neural endpoint 174) then evaluates the priority of the neural texturing request (relative to the other neural network processing task currently being processed). As part of this, it may first be determined whether it is possible to send the neural texturing operations to another shader (processing) core, and if so (step 229—yes), a neural engine in the another shader (processing) core can then perform the required neural texturing operations (step 2210). Otherwise, if it is not possible to do this, it is determined whether the texturing request has higher priority. If so (step 2211—yes), the neural engine 178 job control (i.e. neural endpoint 174) is again operable to pause the current (other) neural network processing task (step 225) to allow the neural texturing operations to be performed (step 226). Whereas, if the texturing request does not have higher priority (step 2211—no), the neural engine 178 is allowed to finish its current task (step 2213) before performing the required texture processing (at step 2214).

Various arrangements would be possible in this regard for handling different neural network processing tasks.

It will also be appreciated that there may be many texturing requests, and these texturing requests may generally require either the same or different neural networks to be loaded in (for example at step 216 in FIG. 21).

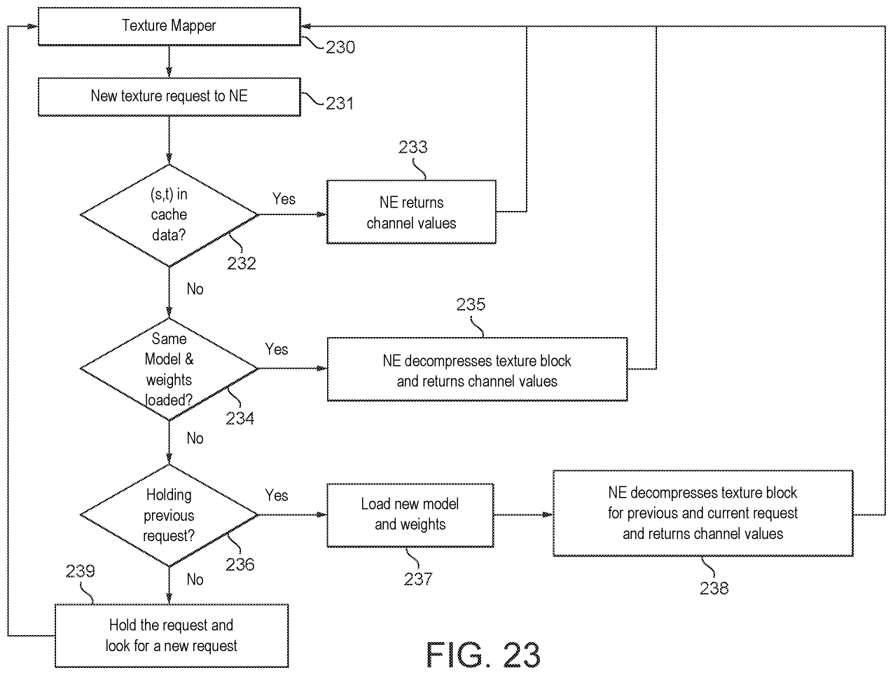

In the worst case scenario a new neural network may need to be loaded for each new texturing request. However, it might be the case that the same neural network is repeatedly loaded in/replaced (e.g., in a similar manner to cache thrashing) and so in embodiments a mechanism is provided to allow texturing requests to be temporarily held in a texturing parking buffer to try to increase opportunities for re-using the same neural network between texturing requests. An example of such a texturing request parking scheme is shown schematically in FIG. 23. Again, FIG. 23 shows such a scheme in the context of the operation described above in relation to FIG. 21 in which the texture mapping unit (texture mapper) 1714 is operable to message the neural engine 178 to request texture data (step 221 in FIG. 22) but it will be appreciated that similar schemes may be used in other examples.

Thus, as shown in FIG. 23, when the texture mapping unit (texture mapper) 1714 (step 230) sends a new texturing request to the neural engine 178 (step 231), the neural engine 178 first checks whether the requested texture data at the specified (s,t) coordinates is already stored locally to the neural engine 178, and if so (step 232—yes), the neural engine 178 returns the required texture channel values to the texture mapping unit (texture mapper) 1714 (step 233). On the other hand, if the requested texture data at the specified (s,t) coordinates is not already stored locally to the neural engine 178, it is then checked whether the texturing request requires the same neural network model and weights that are already loaded into the neural engine 178. If so (step 234—yes), the neural engine 178 then proceeds to decompress the appropriate texture block and return the texture channel values (step 235). Whereas, if the texturing request requires a different neural network to be loaded in (step 234—no), rather than doing this immediately, an attempt is made to hold the texturing request in a suitable texturing parking buffer, to try to find a new texturing request that might use the same neural network model that is already loaded in (and which can therefore be processed immediately). This can then help reduce bandwidth associated with loading in the neural network models between different texturing requests.

Thus, in this case, it is checked whether the texturing parking buffer is already holding a previous texturing request (i.e., the texturing parking buffer is full). If so (step 236—yes), the texturing request should be processed, and so the new model and weights are loaded in (step 237) and the texture decompression performed accordingly (step 238). Whereas, if there is space in the texturing parking buffer for the texturing request, the texturing request is held and the texture mapping unit (texture mapper) 1714 is allowed to look for a new texturing request (step 239).

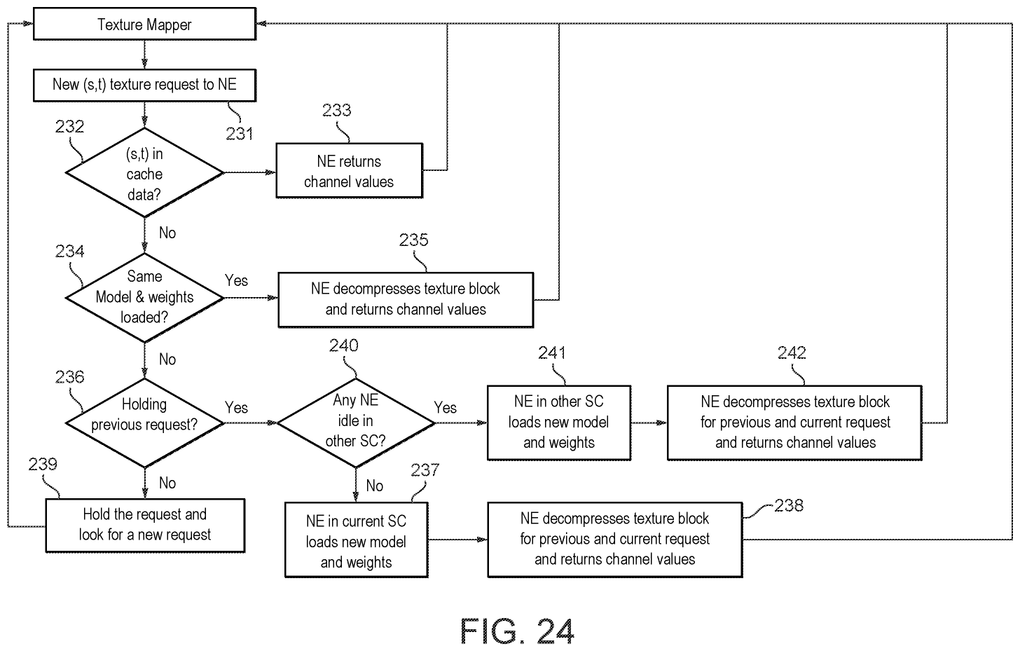

In FIG. 23 it is assumed that neural texturing requests are handled (only) by the neural engine 178 within the shader core as the execution engine 176 and the texture mapping unit (texture mapper) 1714 that trigger the texturing request. However, as mentioned above in relation to FIG. 22, it would also be possible to send requests to neural engines on a different shader core, if one is available. FIG. 24 thus shows a similar holding scheme as shown in FIG. 23 but in the case where it is possible to send requests to neural engines on a different shader core. Thus, the processing of texturing requests in FIG. 24 is generally the same as described above in relation to FIG. 23 except that at step 236, when it is determined that the texturing parking buffer is full, an attempt is made to offload the current texturing request to a neural engine in another shader core. If a neural engine in another shader core is available (step 240—yes), the neural engine in the another shader core is thus caused to load in the new model and weights (step 241) and to perform the required texture decompression (step 242). Otherwise, if there are no available neural engines in other shader cores, the request is processed as described above (steps 237-238).

Various other arrangements would be possible in this regard.

As discussed above, the neural texturing operations of the present embodiments are triggered by the use of dedicated neural texturing instructions that can be included into a shader program to trigger the operations described above.

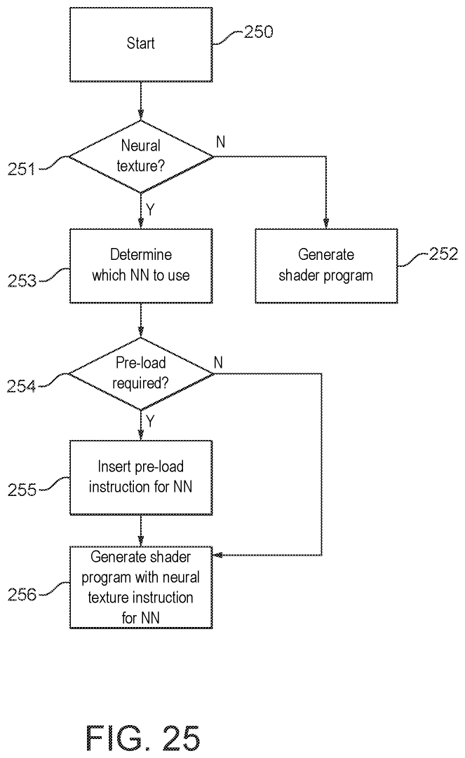

FIG. 25 shows an embodiment of the compilation process.

As shown in FIG. 25, the compiler for the graphics processor will receive a graphics processing program or programs for compiling (step 250).

The compiler will then analyse the shader program code that is provided to identify instances of texturing operations where neutral network based texture decompression is required. If no neural texturing is required (step 251—no), the shader program can then be generated as normal, without requiring any neural texturing instructions to be included (step 252). If the compiler identifies that neural texturing is required (step 251—yes), the compiler is then operable to determine which neural network model is required to perform the neural texturing operations (step 253) and to include an appropriate one or more neural texture instruction using the determined neural network into the shader program (step 256).

As shown in FIG. 25, the compiler may in some embodiments also be able to determine, after the determination as to which neural network model is required (i.e. at step 253), determine whether or not that neural network should be (pre-) loaded in to the graphics processor. Based on a positive determination (step 254—yes), the compiler is then operable to also include into the shader program in advance of the corresponding neural texturing instruction(s) a suitable pre-load instruction for (pre-)loading the determined neural network (step 255).

The compiled shader programs will then be issued to the graphics processor for execution (e.g. stored in appropriate memory of and/or accessible to the graphics processor, so that the graphics processor can fetch the required shader programs for execution as required).

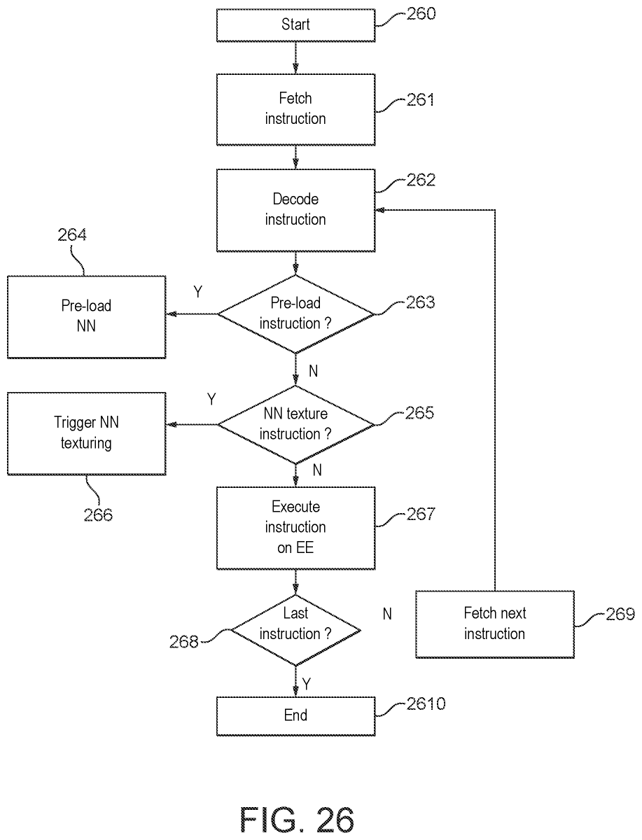

FIG. 26 shows the corresponding execution of such a shader program wherein in response to the graphics processor execution engine executing instructions in a shader program.

As shown in FIG. 26, the execution engine starts executing a shader program (step 260) by fetching the instructions for that shader program (step 261) and decoding these instructions appropriately (step 262) (e.g. in the normal manner for shader program execution).

In the present embodiments, in response to the execution encountering a pre-load instruction for loading in a particular neural network model (step 263—yes), the execution engine is caused to message the neural engine to cause the particular neural network model specified by the pre-load instruction to be loaded into the neural engine.

In response to the execution engine encountering in the shader program a neural texturing instruction (step 265—yes), the neural texturing operations of the present embodiments can thus be triggered. For example, as depicted in FIG. 20 and FIG. 21, this may trigger the execution engine to message the texture mapping unit (texture mapper) and/or message the neural engine, as appropriate, to perform the neural texturing operations.

Otherwise, for other (non-texture related) instructions, the program execution continues by executing the instructions appropriately by the execution engine (step 267) and, so long as there are further instructions in the shader program (step 268—no), fetching the next instruction (step 269). Once the final instruction in the shader program has been executed (step 268—yes), the shader program execution is finished (step 2610).

It will be seen from the above that the present embodiments may therefore provide improved graphics processor support for neural network based texture compression/decompression schemes, thus facilitating the use of such neural network based texture compression/decompression schemes, and in turn improved graphics operation. For example, this can then provide various benefits in terms of increased configurability and flexibility when handling graphics processing texturing requests.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A method of compressing graphics texture data, the method comprising:
selecting a group of plural different textures that are to be compressed using a same neural network; and
using the same neural network to compress multiple, different ones of the textures in the selected group of plural different textures into a first, compressed format.

2. The method of claim 1, wherein the group of plural different textures that are to be compressed using the same neural network is selected such that a desired compression quality threshold and/or level of compression is met for each of the different textures within the group.

3. The method of claim 1, wherein selecting the group of plural different textures that are to be compressed using the same neural network is performed by executing another neural network that is configured to identify groups of plural different textures that should be compressed using the same neural network.

4. The method of claim 1, wherein the graphics texture data is provided at multiple different levels of detail, and wherein the neural network when compressing a texture in the selected group of plural different textures is operable and configured to compress multiple different levels of detail of the texture, the first, compressed format thus storing multiple different graphics textures at multiple levels of detail.

5. The method of claim 1, wherein the graphics texture data comprises plural channels of texture data, the plural channels including a set of colour and optionally transparency channels, and one or more additional channels, and wherein the neural network when compressing a texture in the selected group of plural different textures is operable and configured to compress all of the plural channels of that graphics texture, the first, compressed format thus storing all channels of graphics textures.

6. A method of decompressing graphics texture data, the method comprising:
for a group of plural different textures stored in a first, compressed format, where the different textures in the group of plural different textures are selected such that a same neural network can be used to decompress different ones of the textures in the group of plural different textures:
using the same neural network to decompress multiple, different ones of the textures in the group of plural different textures.

7. The method of claim 6, wherein the first, compressed format stores graphics texture data with a first aspect ratio, and wherein the neural network when decompressing one of the textures in the group of plural different textures is operable to output the texture data at an aspect ratio other than the aspect ratio with which the graphics texture data is stored in the first, compressed format.

8. The method of claim 6, wherein the first, compressed format stores multiple levels of detail of graphics texture data, and wherein the neural network when decompressing one of the textures in the group of plural different textures is operable to output the texture data at a requested level of detail.

9. The method of claim 6, wherein the first, compressed format stores graphics texture data having a number of channels of texture data, and wherein when a request is made for a greater number of channels of texture data than are stored for the first, compressed format, the or a neural network is operable and configured to generate any additional channels of texture data that have been requested.

10. The method of claim 6, wherein the decompression is performed local to and on chip with a graphics processor in response to the graphics processor requesting graphics texture data.

11. A method of operating a graphics processor, the graphics processor comprising a programmable execution unit that is operable to execute programs to perform graphics processing,
the method comprising:
in response to the programmable execution unit executing a first neural texturing instruction that triggers neural network processing to process a first type of graphics texture data from a first, compressed format in which it is stored in memory to a second, uncompressed format for use by the graphics processor:
determining whether data for a first set of one or more selected neural networks for performing the desired neural network processing is stored locally to the graphics processor; and
when the first set of one or more selected neural networks is not stored locally to the graphics processor, the graphics processor loading data for the one or more selected neural networks into the graphics processor accordingly to perform the desired neural network processing;
the method further comprising:
the programmable execution unit subsequently executing a second neural texturing instruction that triggers execution of one or more selected neural networks to perform neural network processing to process a second, different type of graphics texture data, wherein the second, different type of graphics texture data is to be processed using the same first set of one or more selected neural networks that was used to process the first type of graphics texture data; and
the graphics processor using the same first set of one or more selected neural networks to process the second, different type of graphics texture data.

12. The method of claim 11, further comprising:
the programmable execution unit subsequently executing a third neural texturing instruction that triggers execution of one or more selected neural networks to perform neural network processing to process a third, type of graphics texture data that is different from both the first and second types of graphics texture data, and wherein the third, different type of graphics texture data is to be processed using a different set of one or more selected neural networks to that which was used to process the first and second types of graphics texture data; and
the graphics processor loading in data for the different set of one or more selected neural networks to process the third, different type of graphics texture data.

13. The method of claim 12, wherein rather than immediately loading in the data for the different set of one or more selected neural networks to process the third or further, different type of graphics texture data, the graphics processor is operable to temporarily hold the third or further neural texturing instruction and attempt to process a further neural texturing instruction that can re-use the same first set of one or more selected neural networks that was used to process the first and second types of graphics texture data.

14. The method of claim 11, wherein the graphics processor includes a neural network processing circuit that is separate to the programmable execution unit and that is operable and configured to execute one or more neural networks to perform neural network processing for the graphics processor, the method comprising: using the neural network processing circuit to execute the selected neural networks.

15. A method of operating a graphics processor,
the graphics processor comprising a programmable execution unit that is operable to execute programs to perform graphics processing,
the method comprising:
in response to the programmable execution unit executing a first neural texturing instruction for obtaining graphics texture data at a specified level of detail for a specified sampling position within a render output:
the graphics processor fetching a block of graphics texture data containing graphics texture data at the specified sampling position into the graphics processor, wherein the block of graphics texture data is fetched into the graphics processor in a first, compressed format, wherein the block of graphics texture data in the first, compressed format includes data indicative of an array of texture data elements, and wherein there is other than a direct correspondence between the texture data elements and sampling positions so that one or more texture filtering operations should be performed to determine the appearance that the graphics texture should have at the specified sampling position; and
the graphics processor executing one or more neural networks to process the fetched block of graphics texture data to extract texture data representing a filtered texture value at the specified sampling position and level of detail in a second, uncompressed format for use by the graphics processor.

16. The method of claim 15, comprising providing the filtered texture value output by the neural network processing to the programmable execution unit without performing further texture filtering operations.

17. The method of claim 15, wherein the one or more neural networks are operable and configured to perform bilinear filtering of texture data at a single level of detail.

18. The method of claim 15, wherein the one or more neural networks are operable and configured to perform trilinear or anisotropic filtering of texture data across multiple levels of detail.

19. The method of claim 15, wherein the one or more neural networks are operable and configured to process the fetched block of graphics texture data to extract texture data representing the filtered texture value at the specified sampling position and level of detail and at a specified aspect ratio that is other than the aspect ratio in which the graphics texture data is provided in the first, compressed format.

20. The method of claim 15, wherein the graphics processor includes a neural network processing circuit that is separate to the programmable execution unit and that is operable and configured to execute one or more neural networks to perform neural network processing for the graphics processor, the method comprising: using the neural network processing circuit to execute the selected neural networks.
